(19) United States
(12) Patent Application Publication
(10) Pub. No.: US 2026/0245072 A1
(43) Pub. Date: Aug. 20, 2026

(54) ACCESS OR ACQUISITION SYSTEM

(71) Applicant: Albert DAXER, Wilhering (AT)

(72) Inventor: Albert DAXER, Wilhering (AT)

(21) Appl. No.: 19/161,438

(22) PCT Filed: Jan. 31, 2024
(86) PCT No.: PCT/EP2024/052390

§ 371 Date: Sep. 2, 2025

(30) Foreign Application Priority Data
Apr. 4, 2023 (AT) A 40/2023
May 16, 2023 (AT) A 64/2023
May 19, 2023 (AT) A 67/2023

(51) Int. Cl. G06Q 20/36

(52) U.S. Cl. CPC G06Q 20/3674

(57) ABSTRACT

An access or procurement system has at least one device for data exchange and a database and is designed to access data in or from entries in a blockchain, to execute transactions using this blockchain or data derived from it by exchanging a signal in the form of a crypto value with a crypto wallet requesting access, procurement, or execution, to determine the wallet address of a crypto wallet involved in such a transaction, and to determine whether the crypto wallet with the wallet address determined in this way has at least one unique crypto value whose identification code can be found in the database, whose entries correspond to the identification codes of unique crypto values. These unique crypto values registered in this database represent a license for the exercise of a right of access, purchase, or execution by the crypto wallet requesting access, procurement, or execution.

### FIELD OF THE INVENTION

The invention relates to access or procurement systems with secure identification of authorized requests using a blockchain.

### STATE OF THE ART

Historically, access systems have been based on mechanical keys. Only the correct key that fits the lock blocking access allows the user of the key to access an object. Electronic and, in particular, digital access systems also use keys, which are then recognized by a corresponding electronic device. User names and passwords are also common, often accompanied by two-factor identification. One problem here is often remembering user names and, in particular, passwords. Many different access points mean many different access codes (user names, passwords, etc.), which makes administration difficult. If you write down the access codes and keep them in a safe place, they are usually not available when you need them. If you write them down and carry this record with you for constant use, there is a risk of compromise if it falls into the wrong hands. In many cases, password managers can be helpful here, as well as systems that identify predefined physical characteristics that are sufficiently unique, such as fingerprints, faces, or irises, before converting them into electronic identifiers that then grant the appropriate access.

Password managers reduce the number of different logins to a single access code—but the problem of compromising the main password for the password manager remains. A major disadvantage of all these systems is that they are not universally available or are too centrally organized, or that security and uniqueness are not always verifiable in individual cases.

There are approaches using decentralized systems based on blockchain technology to implement property rights via crypto assets (tokens) using “smart contracts” (Lebeau and Mostavi, WO2018213672 A1). This requires the token to be programmed using a computer program that executes instructions in accordance with the “smart contract.” It has also been proposed that proof of ownership rights to real estate or land be represented as a “smart contract” and stored in a blockchain (Daly, US2020193717 A1).

Ownership rights can also be represented accordingly for mobile goods via NFTs as virtual goods in the sense of an electronic “voucher” and, in exchange for such an NFT, the goods represented by it can be obtained at an exchange point (Rice, US2021279695 A1). The secure storage of medical data on NFTs has also been proposed (Kruger and Spurr, US2022406419 A1), as has the secure cryptographic storage of personal data in an NFT (Jakobsson, 202386191 A1). Certain NFTs can also be used in more complex business processes by associating them with a measure of the reputation of bidders in an auction. Other NFTs, after being assigned a financial value, can be used as a deposit, the amount of which may depend on the reputation measure (Vosseller, 2023103398 A1). Overall, such reputation tokens can be obtained from various sources and, by collecting and providing these reputation tokens to an auction organizer, the reputation as a bidder can be proven (Vosseller, US2023108817 A1). These are usually relatively complex systems, some of which work via “smart contracts” that are linked to the tokens as executable code and are not suitable for the task at hand. The execution of an interface through which the token and the computer program actually learn whether a condition for the execution of the “smart contract” has been fulfilled is always problematic. In addition, the tokens often have to be sent back and forth between the systems in a complicated manner in order to maintain permanent functionality. Another problem here is the secure determination of access and procurement authorization.

A blockchain is a decentralized network consisting of a chain of interconnected blocks that store information, values, transaction data, etc. in the form of entries in the blockchain (crypto value). The blockchain enables different participants to validate and verify these entries without the need for a central authority. Various consensus mechanisms can be used for this purpose. For example, the Bitcoin and Ethereum networks use “proof of work” (PoW) as their consensus mechanism. PoW offers extremely high security, but also has high transaction costs and low transaction speeds.

So-called miners, acting as network nodes, have to solve a mathematical problem. Solving the problem is time-consuming and energy-intensive. However, there are also other consensus mechanisms that sacrifice some degree of absolute security in exchange for higher transaction speeds (proof of stake, etc.). Once an entry has been made in the blockchain, it cannot be changed or deleted retrospectively. The entries are therefore secure and unique, and manipulation is not possible. Each entry in the blockchain (transaction) is based on a cryptographic process that uses key pairs (public and private keys). A wallet address of a crypto wallet can be derived from the public key. It is preferably used to confirm that a transaction has been signed by the correct wallet address.

With the help of a wallet address, related transactions and the corresponding transaction history (e.g., incoming and outgoing transactions as well as account balance, etc.) can be tracked in the blockchain. However, the public key or wallet address does not give you control over a crypto asset. To do this, you need the private key that belongs to a specific wallet address linked to the entry in the blockchain.

The private key is necessary to authorize and sign transactions from this wallet address. It is therefore important to keep the private key safe and private. Usually, a master private key for a crypto wallet is generated from 12 secret words (recovery key, recovery phrase, or seed phrase) using a deterministic wallet creation algorithm. The crypto wallet is therefore a kind of access tool for crypto assets or a kind of tool that allows transactions to be carried out in the blockchain via the unique key pair.

It is said that “you transfer (send) something (crypto asset, cryptocurrency, etc.) from one crypto wallet with a specific wallet address to another,” but this means that a new entry is made in the blockchain that securely stores the “transfer” transaction, validates it, verifies it, and makes it unchangeable, along with the corresponding accompanying information (e.g., wallet address, token ID, time, costs, etc.) in the blockchain. Therefore, when the usual term “transfer” or ‘transfer’ from one crypto wallet to another crypto wallet is used in the following, it means that a specific transaction is made with an entry in the blockchain and the power of disposal over the result of the transaction is transferred to the crypto wallet to which the “transfer” was made in accordance with the entry. The accompanying information about the transaction is stored immutably as an entry in the blockchain.

Cryptocurrencies are represented in the Bitcoin network, for example, via Unspent Transaction Outputs (UTXO). The amount of Bitcoin (cryptocurrency) available under a Bitcoin address (wallet address) is referred to as UTXO.

For example, if an amount x in a specific cryptocurrency is transferred or sent from a crypto wallet K1 with the wallet address WA(K1) to the crypto wallet K2 with the wallet address WA(K2), this transaction is stored securely and immutably as an entry in the blockchain, and control over x is transferred from crypto wallet K1 to crypto wallet K2.

Wallet and crypto wallet are used synonymously in this document. In order to carry out “transfers” or “transfers” from crypto wallet K1 to crypto wallet K2, it is normally necessary to know the wallet addresses of K1 and K2, as well as the private key of K1.

Technically speaking, the transaction is stored as a corresponding entry in the blockchain. In order to then be able to dispose of this transferred information (crypto value, cryptocurrency, NFT, etc.), the wallet address K2 and the private key of K2 are required. Possession of the private key is proof of ownership (power of disposal) of a crypto value or of information or value stored digitally or encoded in the blockchain. Information, signal, value, crypto asset (cryptocurrency, token, etc.), identifier, transaction parameters, and parameters can be used synonymously in relation to transactions using crypto wallets or similar devices, depending on the context. This means that “information is transferred from a crypto wallet” is more general than, for example, “a cryptocurrency is transferred from a crypto wallet,” but is nevertheless fundamentally synonymous here-which is clear from logical considerations in the respective context. Crypto assets can be any information in a blockchain, such as cryptocurrencies, tokens including non-fungible tokens, etc., over which a crypto wallet with an associated wallet address has control or which is stored in a blockchain or represented there as an entry after a corresponding transaction.

In fact, however, the crypto asset or the information about the transaction is not stored in the corresponding crypto wallet, but in the blockchain. The crypto wallet is only a tool with which control over it can be exercised. Although crypto assets are technically represented by an entry in the blockchain, they functionally appear as stored in the crypto wallet.

Functionally, i.e., from the perspective of the practical execution of transactions using crypto wallets and their representation in a standard crypto wallet, the cryptocurrencies in question are stored in a crypto wallet or similar device. Functionally, crypto wallets and similar devices, such as crypto exchanges, etc., which enable and summarize the power of disposal over the transactions and values (crypto assets) technically stored in the blockchain, are therefore functionally storage devices for crypto assets. The underlying technical processes in connection with the blockchain are not immediately apparent to the user of a crypto wallet or similar device in terms of the transaction and storage (memory) function of crypto wallets. Functionally, their crypto assets are stored in their crypto wallet and they can functionally send crypto assets to another crypto wallet or receive them from another crypto wallet, for example.

### PURPOSE OF THE INVENTION

The purpose of the invention is to overcome the problems of the prior art and to propose a device and a method which, using a blockchain, overcome the disadvantages of conventional access and procurement systems and, through the simple handling of a crypto wallet with an exchange of crypto values according to the invention using a device according to the invention, enable secure access to a location, an object, or a system (access according to the invention), or secure procurement of a good or service (procurement according to the invention), or, in general, secure execution of a technical process.

### DESCRIPTION OF THE INVENTION

The task is solved by a device according to claim 1 and a corresponding technical method according to claim 7, as well as a computer program product according to claim 8, wherein a property of a crypto wallet, such as the wallet address or the disposal over a unique crypto value (e.g., NFT) is used to establish a license for access or procurement in accordance with the invention and to execute this access or procurement according to specific technical criteria. The access and procurement system according to the invention represents an identification system which can identify a crypto wallet involved in a transaction according to the invention as having access or procurement rights, depending on whether the technical criteria according to the invention are fulfilled. An access and procurement system according to the invention evaluates the criteria according to the invention for exercising an access or procurement right in the real world and manages, regulates, or controls access or procurement or its technical implementation using a blockchain. It opens up access to an object or releases it by unlocking it in some way, or enables the acquisition of a good or executes it if the corresponding criteria according to the invention are met. Further advantageous embodiments of the invention are specified in dependent claims 2 to 6.

In order to exercise access or procurement rights, a signal or information (crypto value) is exchanged between a crypto wallet (end device) and a device according to the invention, wherein the device is equipped to determine whether a corresponding license for access to an object or for the procurement of a good or right, which is preferably implemented as a blockchain-based token with a unique and unmistakable identification, for example as an NFT (non-fungible token), is located in the crypto wallet. The fact that a crypto asset (value) is functionally exchanged between a crypto wallet (wallet) and a device according to the invention, which in turn can be implemented at least in part as a crypto wallet, means technically that the power of disposal over the crypto asset, which is represented by an entry of a corresponding transaction in the blockchain, is exchanged between the crypto wallet and a device according to the invention. In other words, control over the crypto value is transferred from the crypto wallet to the device according to the invention or vice versa. The fact that a crypto asset, such as a specific amount of a cryptocurrency or an NFT, is functionally located in a crypto wallet or device means, in technical terms, that the crypto wallet or device has control over the crypto asset represented by the entry of a corresponding transaction in the blockchain. In the following, one or both representations (functional or technical) will be used depending on the situation.

An access system within the meaning of the invention is any system, devices and processes which, with the aid of (using) a blockchain, technically execute, implement or control (the exercise of rights to) access to a location or object of any kind or a technical system of any kind or the execution of a technical process of any kind, but preferably in the real world, in accordance with criteria specified in the invention, or determine or ascertain the right to do so. Such a location or object or technical system or technical process can be any location, any object, any technical system or any technical process, but preferably in the real world, to which access or execution can be fundamentally limited or restricted. This includes access to an electronic system such as a computer, a digital network, a memory (storage), a computer program (application), etc., or the confirmation of execution requests within a program sequence or a technical process in general, such as the confirmation of a specific transfer within an online banking process. For example, it may be access to a real room (e.g., apartment, locker, house, bank, etc.) in the real world, such as through a locked door that can be physically passed through, or to a device or function of a device (e.g., car, computer, etc.) or to software (database, app, online applications, program, etc.) etc.) that preferably perform functions for the real world, such as transferring or spending money with which real goods can be purchased or another good at a vending machine, placing an order, spending or shipping a real object in the real world, or merely exercising a right, such as boarding a means of transport, etc. For example, if an access seeker desires access to an object (e.g., room) in the real world, such as a person who wants to enter a room with a locked door that is secured (protected) against general access or opening by the access system according to the invention, a corresponding device of the access system according to the invention using a blockchain first determines whether the access applicant has access authorization at all. If this is the case, a corresponding device of the access system according to the invention activates a preferably electromechanical (mechatronic) mechanism, which may be part of the access system according to the invention, in such a way that a corresponding preferably (electro-)mechanical device opens the door and access to the room with the previously locked door is now possible.

Access to software, if it is executed for an activity or application preferably for or in the real world, such as bank accounts, bank transfers, Internet accounts such as Amazon, where real things can be ordered, computers, servers, clouds, software for technical, mathematical, scientific, economic applications, etc., i.e., applications that can be used for processes of daily life or professional life in the real world, can thus also be realized with an invention according to the invention.

A procurement system within the meaning of the invention is any system which, with the aid of (using) a blockchain, technically executes, implements, regulates, or controls (the exercise of rights to) the procurement of a good or service in accordance with criteria according to the invention, or determines or establishes the right to do so. Such a good or service can be any good or service, preferably from the real world (nature), whose procurement can in principle be limited. For example, it can be the right to obtain a certain medication or a digital version of a piece of music or a book, etc. For example, it may be the purchase of a good that can actually be physically consumed by humans, such as a beverage or a medication, etc., or the purchase of a good that may be necessary or helpful for personal use in the real world or the professional world, such as the purchase of a ticket or software for the exercise of a profession to perform tasks in the real world. If, for example, an applicant desires to obtain a good from the real world, such as a person who wants to order a special medication from an online shop, the applicant must prove to a procurement system integrated into the shop during the actual ordering process that they are entitled to obtain the good. Once proof of entitlement has been provided, the procurement system executes the order of the authorized purchaser by, for example, sending an instruction in the form of an electronic signal (message) to a warehouse or shipping system, the executing logistics or technical device of which may be part of the procurement system according to the invention.

The invention is actually an access, procurement, and identification system that allows a technical process to be carried out, which requires the person requesting the execution to be identified as the authorized party, only if a device according to the invention can be proven in a manner according to the invention by a crypto wallet requesting execution (seeking execution) that it has a license for the execution of the technical process, which can preferably be executed as a unique crypto value in the crypto wallet or defined by the wallet address of the crypto wallet.

### Effector

An access or procurement system according to the invention is preferably part of the real world and suitable for directly or indirectly triggering, executing, controlling, or regulating technical processes such as movements of mass-bearing and non-virtual machine elements in the real world by implementation in a technical device of the real world (FIGS. 1, 2). It grants access or procurement if the criterion for access or procurement is met and the corresponding license has been presented or proven to the system. It can be directly or indirectly coupled or connected to or with technical devices such as machines or systems in the real world and, in this way or as part of these devices, machines or systems, trigger, execute, regulate or control technical processes in the real world, by, for example, exchanging mechanical, magnetic, electrical or electromagnetic, optical or acoustic signals, etc. with these technical devices such as machines or systems in the real world. Such technical processes can be, for example, mechanical, electrical, magnetic, optical, electromagnetic or acoustic processes or actions or signals, etc. in or for the real world. Corresponding actions, processes or signals are preferably triggered or executed when a defined access or procurement criterion is met. Further examples include the assisted or automated opening of a door to sensitive areas in a laboratory or medical facility or to a vehicle, an apartment, a locker, etc., or secure access to an electronic or digital area (software), for example on the Internet, or the execution of actions with software which, at least in the broadest sense, has a direct or indirect influence on processes in the real world as described above. In concrete and real terms, access can be granted technically by opening a locker, for example in a bank, by means of a suitable control mechanism, e.g. an electromechanical mechanism. A technical signal within the meaning of the invention would also be, for example, a text message. The mechanism can be integrated to a greater or lesser extent into the system according to the invention and be part of the system, or be fixed or removable, permanent or temporary, connected to the access or procurement system or to a device according to the invention of a system according to the invention.

Not strictly in accordance with the invention, but also not necessarily excluded, would be virtual applications that influence processes, for example in a game in the broadest sense, which can be shared or played locally alone or with the aid of a network (e.g., the Internet).

This also includes virtual worlds as software constructs for entertainment or pastime. However, access to or the purchase of such software may again be in accordance with the invention. In other words, while the control of actions with an access or purchase function within a piece of software or a software application, e.g. in the broadest sense of game software, is not in accordance with the invention, access to or the purchase of such software may be in accordance with the invention. The criterion for assessing whether a device or a process step is in accordance with the invention or not is its direct or indirect effect on the real world.

If, for example, an access seeker desires access to software on a computer or on the Internet, which is protected from general access by an access restriction and this access is only available to authorized persons, access can be granted with an access system according to the invention. However, if the software, i.e., when the software is used, simulates real-world processes that have no direct or indirect influence on actual processes in the real world, such as work, business, medicine, research, everyday life, etc., for example, opening a door in a computer game, then an access or procurement system used for this purpose is not, in the strict sense, in accordance with the invention.

However, if a process is triggered within a software (when using the software) with an access or procurement system that has an effect on the real world, e.g., ordering a real medicine in an online shop, then this access or procurement system can again be considered to be in accordance with the invention by enabling the program sequence for executing the access or procurement by means of a possible release confirmation that requires identification of the requesting party. Accordingly, an action using the software, for example after access to it in accordance with the invention, may also be in accordance with the invention if it has sufficient relevance to the real world or to life in the real world. In this sense, for example, after accessing an online bank account, the confirmation (signature) for executing a money transfer or withdrawal would again be a task for an access or procurement system according to the invention. The reason is that this is real (accepted) money that can be used in the real world to exchange for (other) goods or to purchase goods.

The usual embodiments of the access or procurement system according to the invention require the use (deployment) of a crypto wallet (end device) as an access or procurement requester. In the usual embodiments, direct or indirect communication is possible through the exchange of crypto assets between the crypto wallet or an equivalent device with the same or similar functionality and the device of the system according to the invention. The device can then provide an interface with a transmission and/or reception function for exchanging information that is helpful or necessary for exchanging crypto assets with a crypto wallet. In particular, the interface can encode information suitable for the device according to the invention and display it in a suitable form (e.g., QR code) via a screen, for example. Such information may include the wallet address (WA) of a crypto wallet K, the type of cryptocurrency exchanged (sent or received) (e.g., Ether), the quantity (amount) of the cryptocurrency exchanged (e.g., 0.1 Ether), etc.

The interface could be equipped with a camera that is suitable for recording information with a device (hardware) that hosts, contains, or executes a crypto wallet (software) and processing it in a suitable manner. For example, recording information (e.g., QR code) from a suitable coded representation and decoding or evaluating and processing it in a suitable manner.

The device according to the invention or a part thereof or an interface according to the invention for communication between the crypto wallet and the device according to the invention can be designed as a mobile device or as a stationary device.

Communication between the access or procurement requester (e.g., crypto wallet) and the device of the system according to the invention can take place on the one hand via a suitable interface for exchanging important information for an exchange of crypto values, and on the other hand by connection to a suitable network (Internet, blockchain) for exchanging crypto values (signal).

Communication with the device according to the invention may also be possible by entering (transmitting) an identifier, for example in the form of a password (token ID or license ID or wallet address or a unique identification derived from these), which preferably represents a unique crypto value (token, e.g., NFT) or a wallet address (e.g., FIG. 3). Such an identifier can be transferred, for example, by manual entry via a keyboard on a terminal using an input mask on a screen. The interface can also have or establish an electronic connection or a connection via a network for the transfer of information between the requesting crypto wallet and a device of the system according to the invention.

A distinction is preferably made here between at least four types of communication between a device according to the invention and a party seeking access and procurement (crypto wallet):
1. The exchange of information (transaction parameters, parameters) that is important for a transaction using a blockchain, such as the exchange of a crypto value, and preferably takes place via a suitable interface between a device according to the invention and a crypto wallet. Such information may include the wallet address of a crypto wallet, the identification code (TokenID) of a unique crypto value, the type of cryptocurrency, the amount of cryptocurrency (number of crypto units, amount), etc. They can, for example, be presented as a QR code or another representation for exchange with a crypto wallet or its technical (physical) implementation (e.g., app on a smartphone), e.g., via a screen of the device according to the invention. Preferably, this exchange of information prepares a transaction by exchanging a cryptocurrency between a crypto wallet and the device according to the invention.
2. The exchange of a signal in the form of a cryptocurrency (transaction) between a device according to the invention and a crypto wallet using a blockchain (blockchain network). For this purpose, the device according to the invention has a suitable technical connection to a blockchain (a blockchain network), preferably via an Internet connection. The transfer of a crypto value is preferably carried out by transferring a certain amount in a cryptocurrency, which may also represent an access or procurement fee. This crypto value may also be a unique crypto value (e.g., NFT). The wallet address of the crypto wallet may also be transferred (functionally).
3. The entry of an identifier, such as a password or an order code, which can encode a token ID (TID) or wallet address, by the requesting party, such as the owner of a crypto wallet or a buyer of a good, via a suitable input system (e.g., input mask on a screen of a terminal connected to the device according to the invention or forming part thereof), etc. (e.g., FIG. 3).
4. The transmission (transfer) of a license in the form of a unique crypto value from a device according to the invention or a device functionally and technically assigned to such a device to a crypto wallet. Such devices can also be trading or sales platforms for unique crypto values.

A unique crypto value can therefore function both as a signal and as a license.

### DESCRIPTION OF THE FIGURES

The invention will now be explained in more detail with reference to examples of embodiments. The drawings are exemplary and are intended to illustrate the invention, but are in no way intended to limit or even conclusively reproduce it.

The following is shown:

FIG. 1 shows a schematic structure of an access system according to the invention, in which access authorization to an object or a technical system, etc., is established by means of a license in the form of a unique crypto value (e.g., NFT) in a crypto wallet K.

FIG. 2 shows an extended schematic diagram of an access system according to the invention, in which a license in the form of a unique crypto value (e.g., NFT) in a crypto wallet K establishes access authorization to an object or a technical system, etc., by also schematically representing the exchange of information between the basic elements of the access system and a blockchain.

FIG. 3 shows a flowchart illustrating the steps involved in performing the task according to the invention. The corresponding device processes both the input of an identifier in the form of a password and a signal in the form of a crypto value, which can be exchanged between the crypto wallet K with the wallet address WA and the access or procurement system according to the invention as part of a transaction, in order to decide whether access authorization exists or not. The wallet address of the crypto wallet of the requesting party involved in the transaction acts as the license here. The identifier should be transmitted via a different transmission path than the signal if possible.

FIG. 4 is a flowchart showing the steps involved in performing the task according to the invention when the license is implemented exclusively by the wallet address of a crypto wallet and also schematically showing the exchange of information between the basic elements of the access system and a blockchain.

FIG. 5 is a flowchart showing the steps involved in performing the task according to the invention when the license is implemented by a unique crypto value (e.g., NFT) and also schematically showing the exchange of information between the basic elements of the access system and a blockchain.

FIG. 6 is a schematic representation of a procurement system with the possibility of determining and executing commission payments to an intermediary whose crypto wallet contains a license (intermediary license) in the form of a unique crypto value (e.g., NFT) and which can pass on an order code that is uniquely linked to the identification code of the unique crypto value in its crypto wallet to a buyer for the preferred purchase of a good. This order code is used to identify the intermediary's crypto wallet for the transfer of a commission. The interactions between elements of the procurement system and the blockchain are also shown.

FIG. 7 is a schematic representation of a procurement system with the possibility of determining and executing commission payments to an intermediary whose crypto wallet contains a license (brokerage license) in the form of a unique crypto asset (e.g., NFT) and which can pass on an order code that is uniquely linked to the identification code of the unique crypto value in its crypto wallet to a buyer for the preferred purchase of a good. This order code identifies the intermediary's crypto wallet for the transfer of a commission. Here, the function of the “seller” is split into two separate functions, V1 and V2. The interactions between elements of the procurement system and the blockchain are also shown.

FIG. 8 shows another schematic representation of a procurement system. Here, a signal in the context of a transaction corresponds to the transfer of the order code C.

FIG. 9 shows a schematic representation of the processes in a procurement system when the order code C is linked to the wallet address of the intermediary's crypto wallet.

FIG. 10 shows another schematic representation of the processes in a procurement system when the order code C is linked to the license for mediation in the form of the wallet address of the intermediary's crypto wallet K.

FIG. 11 shows a simplified representation of the processes in a procurement system when the order code C is linked to the identification code of a unique crypto asset (e.g., NFT) as a license for brokering, preferably when the unique crypto asset is located in the crypto wallet K of the intermediary.

FIG. 12 is a schematic representation of the determination of the value of a unique crypto value (e.g., NFT) that has already been in various crypto wallets of intermediaries as a license and has increased its value through its previous functionality.

### METHODS OF IMPLEMENTING THE INVENTION

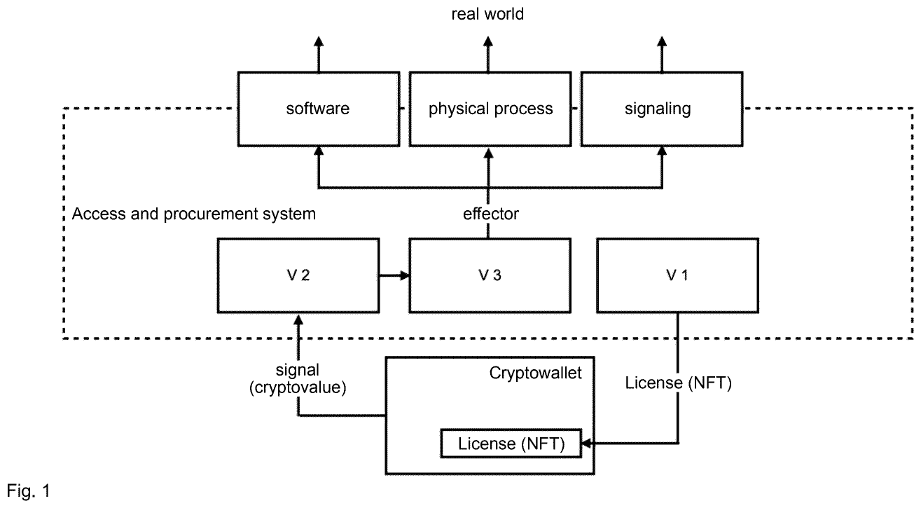

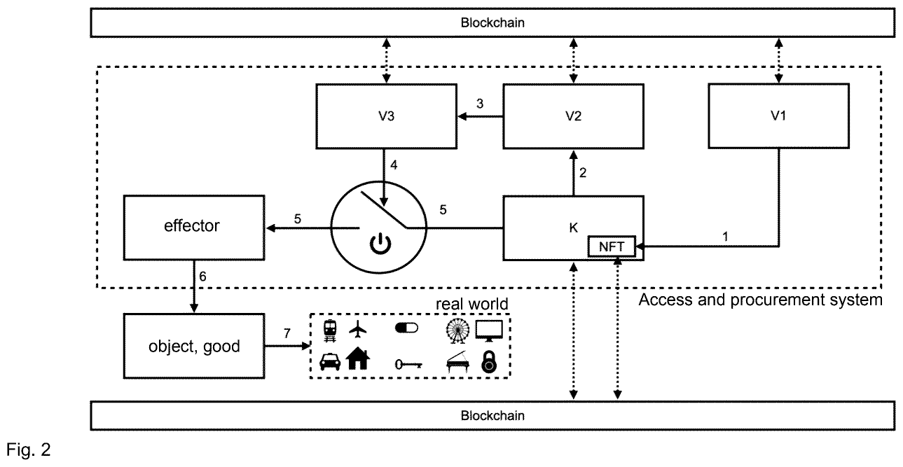

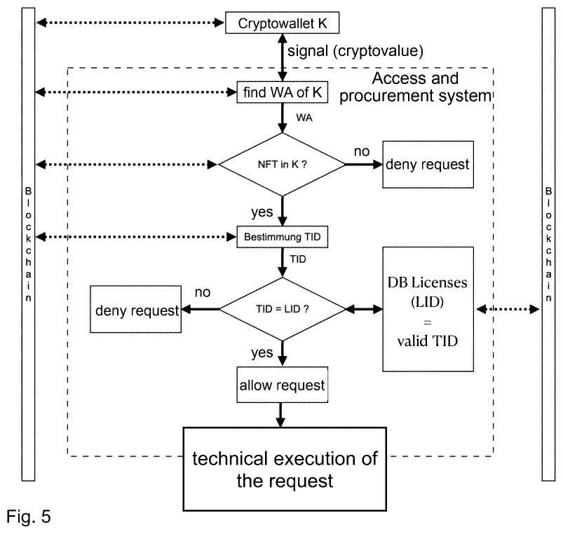

The access or procurement system according to the invention has a device which can exchange a crypto value (signal) with a crypto wallet (transaction) by either taking control of the crypto value from the crypto wallet or transferring it to the crypto wallet (FIGS. 1, 2, 3, 4, 5 or 2 in FIG. 2).

The system (access or procurement system) also has a device that can determine the wallet address of this crypto wallet at least after the transaction has been completed (e.g., V2 or V3). The wallet address can be transmitted directly or indirectly to the device according to the invention. Direct means that (functionally) the wallet address is transmitted to the device according to the invention during the transaction (transfer of a signal (crypto value)) or is transmitted to the device according to the invention via an input terminal, for example. Indirect means that the wallet address of the crypto wallet involved in the transaction is (technically) determined or identified via suitable access by the device according to the invention to data in or from entries in a blockchain. Interactions with an exchange of data from entries in or from a blockchain with a device according to the invention or an access or procurement system according to the invention are preferably represented in the figures by “dotted arrows.”

Technically, the wallet address is determined using information that the access or procurement system or the corresponding device according to the invention generates from the blockchain or from data in or from entries in a blockchain, for example by accessing and reading it there and processing it accordingly. In this sense, the blockchain is also a storage (memory) or database that the access or procurement system according to the invention can access and from which it can generate the appropriate information. Preferably, the device or parts thereof is connected to an electronic network, e.g., the Internet, blockchain, and can thus access databases, technical infrastructure, and functions outside the device in the narrower sense (blockchain). A blockchain can also be part of the device according to the invention.

The transaction can proceed as follows, for example:

If access to an object (e.g., a door) is locked, the device according to the invention preferably presents a suitable representation of information (transaction parameters, parameters) via a suitable interface, which may or may not be part of the access or procurement system, e.g., via a QR code or a character string, etc. on a screen or a sheet or via a technical (e.g., electrical or electromagnetic) connection to a device requesting access or procurement (e.g., a crypto wallet), which is necessary for the exchange of a crypto value with a crypto wallet (transaction) and which can be transferred to the crypto wallet by reading (receiving) it into the crypto wallet.

The reverse case, in which the identifier (information) is presented by the requesting crypto wallet and is recorded (received) by the device, is also conceivable. The identifier (information) preferably contains or encodes at least one of the following characteristics (transaction parameters, parameters): Wallet address of the crypto wallet involved, the address (wallet address) of the device according to the invention for exchanging the crypto value, the type of crypto value to be transferred, the amount of crypto value to be transferred (amount), a transaction identifier, etc.

In any case, from a technical point of view, these properties are primarily determined by information that the access or procurement system or the corresponding device according to the invention generates from the blockchain or from data in or from entries in a blockchain, for example by accessing and reading them and processing them accordingly. Ideally, the identifier (information) is designed (represented) in such a way that, when transmitted to the crypto wallet or the device, for example by scanning a QR code by the crypto wallet, etc., it already contains all the information required for the invention-related exchange of a cryptocurrency (signal, transaction) between the device and the crypto wallet requesting access (e.g., type of cryptocurrency, amount of cryptocurrency, wallet address of a participating device or crypto wallet, if applicable) and, after the identifier has been read, only needs to be confirmed via a “Send” or “Receive” function, depending on how the transfer of the cryptocurrency has been agreed in the specific system (access or procurement system). This is the functional view of the process. From a technical perspective, this information is processed via the blockchain.

With the help of the information exchanged via the interface (transaction parameters), a transaction (exchange of a crypto value (signal) between the crypto wallet and the device according to the invention) is then prepared and executed. The crypto asset or the power of disposal over the crypto asset is exchanged between the crypto wallet and the device according to the invention during this transaction, i.e., it is transferred from the crypto wallet to the device according to the invention or vice versa. For this purpose, the device according to the invention is connected to a blockchain or a blockchain network, for example via a suitable Internet connection. The device according to the invention then uses the blockchain and other (internal) databases to determine important data for deciding whether access or procurement rights exist, such as the wallet address of the crypto wallet involved in the transaction, the identification code (TokenID) of any unique crypto value“ located” in the crypto wallet, etc.

With the help of this important data, the device according to the invention determines whether the crypto wallet requesting access or subscription has access or subscription rights. This is preferably done by the device checking whether the crypto wallet requesting access or subscription has a license. This process can be implemented differently depending on the embodiment.

If the access or procurement authorization exists because the crypto wallet requesting access or procurement has a corresponding license, access or procurement is granted and, if necessary, the specific execution of the release of access (e.g., opening a door) or procurement (e.g., production or shipment of goods) is realized using an effector according to the invention. A license is used to determine the corresponding authorizations, which can be implemented differently depending on the embodiment (e.g., wallet address of a crypto wallet, unique crypto value or its identification code (identifier, token ID, license ID, TID, LID)), etc.

In any case, a person entitled to access or obtain must acquire an access or usage right (license) by applying for it and finally being assigned it by a corresponding authorized body. The access or procurement right (license) is granted (realized), as described in the corresponding embodiments, either by transferring a unique crypto value (e.g., NFT) to the crypto wallet of the access or procurement applicant and entering a unique identifier of this crypto value (TokenID) is entered into a database of valid unique crypto assets of the access or subscription system according to the invention, and the TokenID (TID) thus becomes the LicenseID (LID). However, the access or procurement right can also be granted (realized) by entering the wallet address or an identifier of the crypto wallet that is to be used to exercise the access or procurement right in a database of valid wallet addresses. The corresponding valid wallet address is then the license ID. A combination of both requirements (correct wallet address and correct TokenID) may also represent the access or subscription right.

First, a license L is created, which establishes rights to a real-world asset or access to an object, for example. This license is then represented as a crypto asset, e.g., as a token, or as a wallet address in the blockchain, which has its own, preferably unique, electronic (e.g., alphanumeric) identification (identification code, identifier), the license ID, e.g., a non-fungible token (NFT) or the wallet address. This can be done on an Ethereum-based blockchain, for example. However, any other basis is possible. A token is generated (mined, minted) to which a license is assigned or which represents a license. In the case of an NFT, a specific license, e.g., license no. 4711, which can be distinguished from other licenses not only by its unique identification code but also by its content (rights) or its value or by another characteristic such as the number of sales of a good, value of a real estate or property share or a real estate or property from other licenses, can be assigned to a specific NFT, e.g., NFT No. 4711 (LicenseID). The textual content of the license, which describes how and under what conditions the license establishes a right to a real-world asset, may be attached to the token as text or encoded therein, or may be available for general viewing or for viewing only by the token holder somewhere on the Internet. Throughout this document, the terms “license” and the terms “token,” “NFT,” “unique crypto value,” “identification code,” “identifier,” “TokenID,” “TID,” “LicenseID,” “LID,” etc., which may represent the license, may be used interchangeably depending on the context.

### 1. Embodyment (Wallet Address=License):

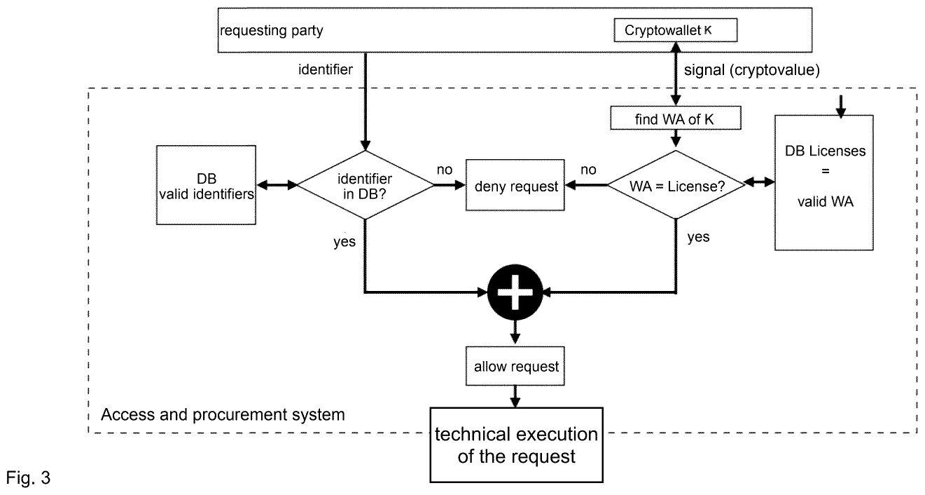

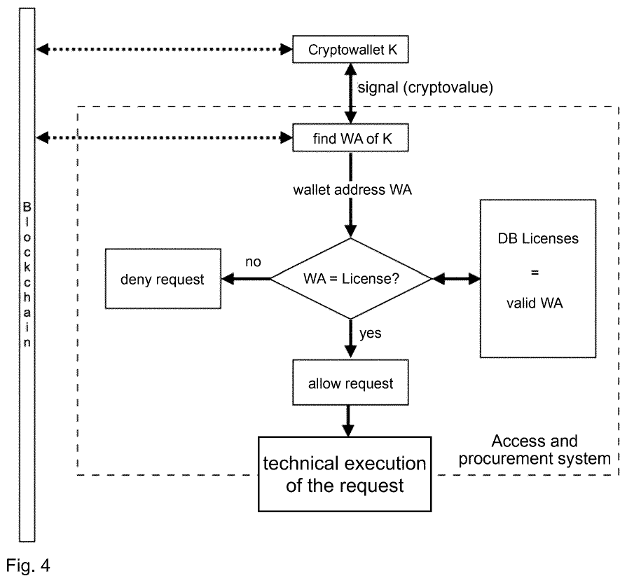

In a specific execution form (FIGS. 3 and 4), the device has a database (database of valid wallet addresses) in which those wallet addresses are listed for which access or procurement authorization (license) has been granted. If the wallet address of the crypto wallet used in a transaction requesting access or procurement is found in this database, access to an object or the procurement of a good can be granted. The corresponding transaction is the exchange of a signal (crypto value) between the crypto wallet and the device according to the invention. The wallet address of the crypto wallet involved in the transaction is determined by a device according to the invention. Functionally, the wallet address can be transmitted together with the signal. Technically, this is done by the device according to the invention determining the wallet address from data in or from entries in the blockchain. Preferably, a device according to the invention accesses data in or from entries in the blockchain in a suitable manner and processes it according to the invention. After determining the wallet address, a (further) device according to the invention of the system or a module of a device according to the invention (control, control device, control apparatus) determines whether this wallet address is listed in a database of (valid) wallet addresses, which contains those wallet addresses that establish the right to access the object or to obtain the goods in question (license).

The entry of a wallet address in the database of valid wallet addresses is preferably carried out after a registration process by a device according to the invention. During the registration process, the access or procurement applicant must prove, preferably by means of suitable identification via the device according to the invention, that they have control over the crypto wallet to be registered. This can be done, for example, by transmitting the wallet address of the crypto wallet to be qualified (access or subscription applicant), for example via an input mask from a terminal connected to the device according to the invention, or by exchanging a signal between the crypto wallet and the device according to the invention, or transmitting a signal (crypto value) from the crypto wallet to the device according to the invention, preferably with (functional) transmission (co-transmission) of the corresponding wallet address to the device according to the invention, or both. This exchange of a signal (crypto value) is preferably preceded by the exchange of information (transaction parameters) between the crypto wallet and the device according to the invention, which are important for this exchange of a signal (crypto value), such as wallet address, size (amount) and type of crypto value, etc., via an interface according to the invention. The determination of the wallet address during the (functional) exchange of a signal (crypto value) between a crypto wallet and a device according to the invention is (technically) achieved, for example, by the device according to the invention determining or establishing the wallet address of the crypto wallet via accesses to data in or from entries in a blockchain according to the invention. The wallet address defined or determined in this way can then be entered into the database of valid wallet addresses as a largely anonymous license.

In addition, it is conceivable that, for legal or tax reasons, further information, such as proof of a fundamental right of use or purchase, could be used as criteria for registration. For example, when accessing an apartment, that the applicant is actually the tenant or the owner, or when obtaining a prescription, that the applicant is a doctor or patient entitled to receive a particular medication. This includes, for example, address, name, date of birth, etc.

The crypto wallet address determined in this way is then entered by the device according to the invention into the database of valid wallet addresses of the device according to the invention. The crypto wallet itself then represents the license and the associated wallet address, the License ID (LID). The device according to the invention (in accordance with the steps of the invention) thus determines whether the access or procurement applicant really has control over the crypto wallet to be registered.

If, after exchanging a signal (crypto value) with the device according to the invention, the wallet address of a crypto wallet requesting access or procurement matches a wallet address in the aforementioned database (database of valid wallet addresses) (e.g., crypto wallet =license, wallet address =license ID), the criterion for access to the object or the purchase of the goods in question is deemed to be fulfilled and access is granted or the purchase is authorized. This can be done, for example, by the device displaying this authorization on a display such as a screen or by means of another signal (e.g., green LED) and indicating to a person responsible for exercising the access authorizations that they may grant access to the customer, passenger, etc., who has requested access using their crypto wallet, and that they can let them pass. However, the device can also generate a corresponding technical signal which causes a corresponding mechanism (effector) to open a door that prevents the desired access (e.g., the electromechanical opening of a lock). If the wallet address involved in the transaction does not appear in the database of valid wallet addresses, no signal is emitted or, for redundancy reasons, a corresponding signal is emitted indicating that the requested access cannot be granted. In this example, the wallet address of the crypto wallet involved establishes the license for access to an object or for the procurement of a good if it is entered in the database of valid wallet addresses. Provided that the database is sufficiently well protected against manipulation by third parties, the access or procurement system is completely secure and no unauthorized access or procurement can be obtained.

### 2. Embodiment (Token=License):

In a further embodiment (FIGS. 1, 2, 5, 6, 7, 8), a unique crypto value, namely a token with a unique identification (identification code, token ID, TID) such as an NFT (non-fungible token), represents the license for access to an object or for the purchase of a good. In this case, the crypto wallet requesting access or purchase should have the token representing the corresponding license. Previously, this unique crypto value (e.g., NFT) must be generated (“mined, minted”) by an invention-compliant device V1 using a blockchain and stored in a suitable device using a blockchain, where it is available for transfer to a crypto wallet. Then, the token (NFT) must be transferred (functionally) to the crypto wallet requesting access or subscription so that it (technically) has it at its disposal.

### Acquisition of the NFT

The transfer of a unique crypto value (e.g., NFT) to a crypto wallet can be done, for example, by a device V1 according to the invention transferring the NFT to a specific crypto wallet with a specific wallet address that has been determined in advance in any manner. The wallet address of the crypto wallet to which the NFT is to be transferred can be specified in advance, for example by exchanging this information in any way. For example, it is conceivable that the wallet address (target address) of the crypto wallet is transmitted electronically to the device according to the invention.

It is also possible that the device according to the invention V1 offers the NFT via a suitable interface or a corresponding platform (e.g., website on the Internet, online shop, trading or sales platform, etc.) for transfer to a crypto wallet on the basis of a free acquisition or purchase. Via a corresponding interface, information that is important for this exchange of an NFT can first be exchanged between the crypto wallet and the device according to the invention (in preparation for the transfer of the NFT). Such information (transaction parameters) may include, for example, the wallet address of the crypto wallet, the identification code (TokenID, TID) of the unique crypto value, the price for the acquisition of the NFT, etc. Once both parties have the information necessary for the transfer of the NFT, the NFT can be transferred (functionally) to the crypto wallet. With the transfer of the NFT to a crypto wallet, for example in the case of the purchase of the NFT, a certain amount of cryptocurrency or another crypto value can also be transferred from the crypto wallet to the device V1 according to the invention.

NFT is a specific form of a unique crypto value. However, for the sake of readability and unless the context indicates otherwise, NFT is used here and elsewhere as a synonym for the general term “unique crypto asset” or “unique crypto value.”

Once the unique crypto asset (token, e.g., NFT) is in the requesting (access or procurement requesting) crypto wallet, which seeks access to a specific object or the purchase of a specific good, the prerequisite for qualification as a license in the form of a unique crypto value (e.g., NFT) for the exercise of the corresponding access or procurement right by the corresponding crypto wallet is generally fulfilled.

### Important Features of a Device According to the Invention

The device according to the invention can be designed so that it can determine, via suitable access to data in or from entries in the blockchain used, whether an NFT is in the possession of a crypto wallet with a specific wallet address.

The device according to the invention can be designed so that it can determine, via suitable access to data in or from entries in the (invention-related) blockchain used, which identification code (TokenID, TID) is assigned to an NFT in the possession of a crypto wallet.

The device according to the invention can be designed so that it can determine, via suitable access to data in or from entries in the (invented) blockchain used, whether an NFT in general or a specific NFT defined by its TokenID (TID) has ever been in the possession of a crypto wallet with a specific wallet address.

The device according to the invention can be designed so that it can determine the wallet addresses of all crypto wallets with which an NFT with a specific TokenID (identification code, TID) has ever been located via suitable access to data in or from entries in the blockchain used.

The device according to the invention can be designed so that it can determine the wallet address of a crypto wallet with which a signal in the form of a crypto value was exchanged with the device according to the invention via suitable access to data in or from entries in the blockchain used.

The device according to the invention can be designed so that it can determine the wallet address of a crypto wallet that has transmitted a signal in the form of a crypto value to the device according to the invention via suitable access to data in or from entries in the (invention-related) blockchain used.

The device according to the invention may have a database, or at least have access to one, which contains at least a direct or indirect identifier (identification code) or identification of the valid or authorized tokens (e.g., NFT) in the sense of a license for the exercise of a corresponding access or subscription right. In other words, in certain forms of application, the device according to the invention can have a database of valid unique crypto values in which those identification codes (TokenID, TID) of unique crypto values are listed which represent an access or procurement right within the meaning of the invention. The device according to the invention can determine whether an NFT has been generated or “mined, minted” in a crypto wallet by or through the device according to the invention.

### Registration

In a simple, highly anonymous variant of this embodiment, there is no registration process in the strict sense. The registration process here consists solely of a unique crypto value (NFT) according to the invention, which represents a license within the meaning of the invention, being transferred from a device according to the invention to a crypto wallet requesting access or procurement. The device according to the invention then checks, for each transaction requesting access or procurement (exchange of a signal (crypto value)) between the crypto value and the device according to the invention, whether a unique crypto value (license) according to the invention is present in the crypto wallet. In a specific variant, this can be done with the aid of a database of valid unique crypto values in which the NFTs according to the invention, which represent a license, are listed.

It is also conceivable that the registration process requires, for example, the entry (transmission) of an identification code (TokenID, TID) of a unique crypto value to the device according to the invention, for example by entering this identifier via an input mask from a terminal. This can be combined with entering the wallet address of the crypto wallet in which the unique crypto value (e.g., NFT) is located.

The device according to the invention then checks in a manner according to the invention whether the unique crypto value is actually located in the entered crypto wallet. If this is the case, the identification code of the unique crypto value (license) can be entered into a database of valid unique crypto values and, if necessary, the entered wallet address can also be entered into a database of valid wallet addresses.

In a more detailed and less anonymous, but more personalized registration process, after the NFT has been transferred to the access-or procurement-seeking crypto wallet, a transaction, namely the exchange of a signal (crypto value) between the crypto wallet and the device according to the invention, e.g., in the form of the transmission of a signal (crypto value) from the crypto wallet to the invention according to the invention, preferably with (functional) transfer (co-transfer) of the wallet address of the crypto wallet. After the wallet address of the crypto wallet involved in the transaction has been determined in accordance with the invention and whether a unique crypto value is located in the crypto wallet involved in the transaction, and if so, what identification code it has, the corresponding entry of the identification code and, if applicable, the wallet address can then be made again in the described databases (database of valid unique crypto values, database of valid wallet addresses).

The device according to the invention can, if necessary, also only check whether a unique crypto value (NFT) according to the invention is located in the crypto wallet by determining whether it is an NFT originating from the device according to the invention. If the device according to the invention then determines that such an NFT is located in the crypto wallet, the prerequisite for registering the unique NFT as a license granting access or use is generally fulfilled.

In order for the device according to the invention to determine whether an NFT according to the invention is located in a crypto wallet, the wallet address of the crypto wallet that has exchanged a signal in the form of a crypto asset with the device according to the invention is first determined via suitable access to data in or from entries in the (invention-related) blockchain used.

Before the transaction in the form of an exchange of a signal (crypto value) between a crypto wallet and a device according to the invention, in preferred embodiments, the exchange of information that is important for the transaction is required. This exchange of information preferably takes place via a suitable interface between a device according to the invention and a crypto wallet. Such information may include the wallet address of a crypto wallet, the identification code (TokenID) of a unique crypto value, the type of cryptocurrency, the amount of cryptocurrency (number of crypto units, amount), etc. They can, for example, be presented as a QR code or another representation for exchange with a crypto wallet or its technical (physical) implementation (e.g., app on a smartphone), e.g., via a screen of the device according to the invention.

In addition, it is conceivable that further information may be required for legal or tax reasons, such as proof of a fundamental right of use or purchase. For example, in the case of access to an apartment, that the applicant is actually the tenant or owner, or in the case of a purchase, that the applicant is an authorized physician. This includes, for example, address, name, date of birth, etc.

If the device according to the invention determines during this registration process that the unique crypto value (NFT) in the crypto wallet establishes a license for access to a location or for the purchase of a good, the identification code (TokenID, TID) of this unique crypto value can be entered into a database of valid unique crypto values of the device according to the invention.

### Process

For each transaction requesting access or procurement (exchange of a signal (crypto value)) between a crypto wallet requesting access or procurement and the device according to the invention, the device according to the invention checks whether a unique crypto value (license) according to the invention is located in the crypto wallet. If the device according to the invention then determines with this process that such a license is located in the crypto wallet, access is granted or the procurement is granted (executed).

In the process by which the device according to the invention determines whether a license, for example in the form of an NFT, is located in a crypto wallet, the wallet address of the crypto wallet that has exchanged a signal in the form of a crypto value with the device according to the invention is first determined via suitable access to data in or from entries in the (invention-related) blockchain used.

In preferred embodiments, the exchange of a signal (crypto value) between a crypto wallet and the device according to the invention is preceded by the exchange of information (transaction parameters) that is important for a transaction using a blockchain, such as the exchange of a crypto value. This is preferably done via a suitable interface between a device according to the invention and a crypto wallet. Such information may include the wallet address of a crypto wallet, the identification code (TokenID) of a unique cryptocurrency, the type of cryptocurrency (e.g., cryptocurrency or NFT), the amount of a cryptocurrency (number of crypto units, amount), etc. For example, they can be presented as a QR code or another representation for exchange with a crypto wallet or its technical (physical) implementation (e.g., app on a smartphone), e.g., via a screen of the device according to the invention.

A unique identifier or identity, identification code of unique crypto assets (tokens, e.g., NFT), TID represents in this disclosure, unless otherwise specified, a token ID or a representation derived therefrom. The identification code (TID) of those unique crypto values (tokens, e.g., NFT) which represent a license for access or a procurement in accordance with the invention and which are preferably located in the database of valid unique crypto values or represented therein are referred to in this disclosure as LicenseID, unless otherwise specified. The set of License IDs is therefore a subset of the Token IDs. Their basic properties are therefore the same. They differ only in that License IDs are Token IDs that are preferably stored or represented in the database of valid unique crypto values. This means that the database contains the identifier of at least one token (TokenID) which represents the unique identification of the corresponding valid token (e.g., NFT) (LicenseID).

Such an identifier (TokenID) is implemented in its digital processing, for example, by a sequence of a certain number of bits. The length (number of bits) may vary between different identifiers. Nowadays, such identifiers are usually represented by an alphanumeric character combination. In the case of a device with a system for storing, representing, or processing signals based on quantum probabilities (e.g., quantum computers), the identifier preferably contains probability values between 0 and 1.

In one variant (this embodiment), the (requesting) crypto wallet that desires access to an object or the purchase of a good exchanges a signal (crypto value) with a device of the system according to the invention using the blockchain in a manner according to the invention (transaction). Functionally, a crypto wallet seeking access or procurement exchanges a crypto value with a device according to the invention, for example by the crypto wallet transferring the crypto value to the device according to the invention or vice versa.

After the wallet address of the crypto wallet that exchanged the crypto value (signal) with the device has been determined in accordance with the invention, as already described, a separate (additional) device, which preferably performs a suitable analysis of data in or from entries in the blockchain available information (entries), whether there is at least one unique crypto value (token, e.g., NFT) in the requesting crypto wallet. This is preferably done by a device according to the invention accessing data in or from entries in a blockchain in a suitable manner and processing it according to the invention. If such a unique crypto value is found in the requesting crypto wallet, the device according to the invention or a specific module of the device preferably uses a blockchain to determine or identify the identification code (TID) of the unique crypto value or values in the crypto wallet.

A device according to the invention or a corresponding module thereof then determines whether the identifier or identification (TokenID) of a unique crypto value (token, e.g., NFT) detected in the requesting crypto wallet can be found in the database of valid unique crypto values. If this is the case (TID=LID), the identifier or identification code of a unique crypto value (token, e.g., NFT) detected in the requesting crypto wallet is in the database of valid unique crypto values, the criterion for access to the object or for obtaining the goods in question is deemed to be fulfilled and access is granted or the procurement is enabled or executed.

As already described in another embodiment or in general, this can be done, for example, by the device displaying this authorization on a display such as a screen or by means of a signal (e.g., a green light (LED)) and indicating to a person responsible for exercising the access authorizations that they may grant access to the customer, passenger, etc., who has requested access with the transaction using their crypto wallet, and that they can let them pass. However, the device can also generate a corresponding technical signal which causes a corresponding mechanism to open a door that prevents the requested access (e.g., the electromechanical opening of a lock).

If there is no unique crypto value in the requesting crypto wallet or if the TID of the unique crypto value detected in the requesting crypto wallet cannot be found in the database of valid unique crypto values, the corresponding access or procurement cannot be granted and either no signal or, for redundancy reasons, a corresponding (negative) signal (e.g., red light) indicating that the desired access cannot be granted. In this example, a valid unique crypto value located in the requesting crypto wallet establishes the license for access to an object or for the purchase of a good (TID=LID). Provided that the corresponding database is sufficiently well protected against manipulation by third parties, the access or procurement system is absolutely secure and no false access or procurement can be obtained.

In summary, an access or procurement procedure, preferably and without definitive specification of all the steps listed and the order in which they are performed, is as follows:
1. Generation of a unique crypto value (e.g., NFT), preferably by means of an invention-compliant device.
2. Transfer of a unique crypto value (e.g., NFT) from an invention-compliant device to a crypto wallet.
3. Registration of the NFT transferred to the crypto wallet as a license for access or procurement in accordance with the invention by qualifying the unique crypto value (e.g., NFT) as a valid unique crypto value (license) in the device according to the invention.
4. Exchange of information (transaction parameters) via an interface between a crypto wallet and the device according to the invention in preparation for a transaction between the crypto wallet and the device according to the invention.
5. Executing a transaction by exchanging a signal in the form of a crypto value (e.g., cryptocurrency, NFT) between a crypto wallet seeking access or procurement and a device according to the invention.
6. Determining the wallet address of the access-or procurement-seeking crypto wallet involved in a transaction (exchange of a signal in the form of a crypto value (e.g., cryptocurrency, NFT)), preferably via access to data in or from entries in a blockchain by means of a device according to the invention.
7. Determining whether the access-seeking or procurement-seeking crypto wallet was involved in a corresponding transaction and is identified via the determined wallet address and has at least one unique crypto value (e.g., NFT).
8. Denying access or a procurement in accordance with the invention if the device according to the invention cannot determine a unique crypto value (e.g., NFT) in the access-or procurement-seeking crypto wallet that was involved in a corresponding transaction.
9. Determining the unique identification code (TID) of a unique crypto value (e.g., NFT) identified by the device according to the invention, if applicable, in the access-or procurement-seeking crypto wallet involved in a transaction.
10. Determining whether an identification code (TID) determined by the device according to the invention for a unique crypto value determined in an access-or procurement-seeking crypto wallet qualifies as a license for access or procurement according to the invention in the device according to the invention (registered) by the identification code appearing preferably as an entry of this identification code in a database of valid unique cryptocurrencies.
11. Denying access or a procurement in accordance with the invention if an identification code (TID) of a unique crypto value detected in a crypto wallet requesting access or procurement is not qualified (registered) in the device according to the invention as a license for access or procurement according to the invention because, for example, the identification code does not appear as an entry in a database of valid unique crypto values.
12. Granting access or a procurement according to the invention if an identification code (TID) of a unique crypto value detected in a crypto wallet requesting access or procurement is qualified (registered) in the device according to the invention as a license for access or procurement according to the invention, for example because the identification code appears as an entry in a database of valid unique crypto values.
13. Execution of the access or procurement right associated with the license by activating an effector that technically executes the access or procurement process.

In another variant of the embodiment, the requesting (access-or procurement-seeking) crypto wallet, i.e., the crypto wallet that seeks access to an object or the purchase of a good, transmits a unique crypto value (e.g., NFT) as a signal to the device according to the invention. Logically, this can only be done once without retransmission. The device according to the invention then determines the identifier or token ID of the unique crypto value and compares it with the entries in the database of valid unique crypto values. If the identifier (TID) matches an entry in the database of valid unique crypto values (LID), the criterion for granting access to a (specific) object or the purchase of a (specific) good is deemed to have been met and access or procurement (purchase) is granted.

If only one unique crypto value is used as the criterion (license) for access or procurement, the only thing that counts is that a valid unique crypto value is in the crypto wallet or was in the crypto wallet immediately before transmission to the device according to the invention. Which crypto wallet is or was involved in the transaction is irrelevant in this variant for the fulfillment of the criterion for granting access or receipt. The NFT transmitted as a signal then corresponds to a valid ticket that was purchased in advance. It does not matter who hands over the ticket at the entrance. The unique crypto value may have been located in different crypto wallets after purchase or before the specific request for access or purchase. Just as a corresponding admission ticket can be given to someone else after purchase, who then exercises the right of access to the event. This is therefore comparable to an admission ticket to an event such as a congress or trade fair that is not personalized—i.e., anyone who has this admission ticket may enter.

In a further variant, in addition to the unique crypto value as a signal exchanged between the requesting crypto wallet and the device according to the invention, the wallet address of the requesting crypto wallet can also be used in the manner already described, for example after a suitable registration process involving the entry of the wallet address of the requesting crypto wallet in which the unique crypto value sending the signal is or will be located, as a criterion for granting access or procurement rights. Access or procurement can only be granted if the signal in the form of a unique crypto value is transmitted to the device from a crypto wallet registered in the database of valid wallet addresses. This corresponds to a personalized admission ticket. Only the registered person may use the admission ticket.

In a further variant, in addition to the signal, an identifier, for example in the form of a password, can be transmitted to the device according to the invention, preferably via a different transmission path than the signal.

The execution of the license and the signal exchanged between the requesting crypto wallet and a device according to the invention in the form of an NFT is therefore particularly advantageous when it comes to authorization for a very specific, unique right. As a simple example, admission to an event can be cited, representative of all logically similar applications, such as the right to a specific seat at an event:

The authorizing party (organizer, e.g., a theater) offers special rights to an authorization applicant via its website (e.g., defined seats for a specific performance in the sense of theater tickets) (FIG. 1). For example, for procurement or, in general terms, for acquisition. If this acquisition (purchase) takes place or if the entitlement is granted in another way, the entitlements issuer (organizer) or a company acting on its behalf transmits a unique crypto value (e.g., NFT) that represents this entitlement (e.g., a specific seat at a specific event, such as event xyz, on date-time, seat 131) to the crypto wallet K of the requester. Instead of, for example, theater tickets in paper form or an electronic image on a mobile phone (both of which can be forged), the NFT provides an absolutely forgery-proof admission ticket. When the entitlement is exercised (e.g., upon entering the theater), the NFT (with a specific token ID) is transmitted from the crypto wallet K to a device according to the invention (receiving device (e.g., via a suitable network)) that functionally has a memory for storing the NFT (e.g., wallet) which has an electronic control device for checking whether the NFT represents the claimed authorization.

The control device has a device that can determine whether the transferred NFT is actually the one that was previously transferred from the device according to the invention to the crypto wallet, or whether the NFT was generated (minted) by a device authorized by the authorization issuer (license generation) before the NFT was transferred to K. In other words, it must be determined whether the NFT was actually generated by the authorization or license issuer (organizer) for this particular authorization and represents the authorization claimed by W. The same applies if only the token ID was transmitted to the control device and/or an additional signal from K to the device according to the invention. The (digital) storage (memory) location may also be the location where the NFT was created. The verification can be carried out, for example, via an identification for the license, such as the token ID of the NFT, in the control device, e.g. by comparison with a list of valid token IDs from an electronic or digital database and/or by the control device having a device that can determine whether the license (NFT) belongs to those NFTs that represent an entitlement or in which crypto wallet the NFT has ever been located, and/or whether the NFT was transferred to K by the device according to the invention, or whether the NFT has ever been at the disposal of the device according to the invention, and/or whether the NFT has ever been in K and/or whether the NFT is currently in the K to which the NFT was transferred by the device according to the invention, and/or in which wallet the NFT is currently located. V1, V2, and V3 may be identical to each other.

The wallet address of V1 and V3, if any, should be available to the control device for processing, or should be transmitted to it or be available in a database.

In fact, a device according to the invention generates this information by means of suitable accesses from data in or from entries in the blockchain.

If the control device has a device that can check whether the NFT was mined, minted by V1 or an associated device (authorization issuer) or was stored in V1 (before it was transmitted to K), the authorization or license or NFT (e.g., theater ticket) can also be passed on from K to another wallet, and the wallet that ultimately contains the license has the authorization (e.g., theater ticket). This authorization can then be transferred to another wallet by transferring the NFT theater ticket) also be passed on by K to another wallet, and the wallet that ultimately contains the license has the authorization (e.g., theater ticket). This means that this authorization can be passed on multiple times by transferring the NFT from K to another crypto wallet. In other words, the theater ticket can be sold or transferred to someone else. In this way, ticket offices or other participants in a secondary market can become active. Generally speaking, this makes it possible to establish a secondary market for the corresponding entitlement (license), whereby the entitlement is always located where the license (NFT) is located in the crypt o wallet. With the NFT, the authorization is currently in the crypto wallet in which the NFT is currently located. This crypto wallet can claim the authorization. However, if the control device has a device V3 that can check or verifies whether the license (NFT) (e.g., at the entrance to the theater before the performance) is actually the one to which the license (NFT) was previously transferred by V1, and makes this an additional criterion for authorization, this excludes authorization after transfer. The NFT is used to transfer the current address of the crypto wallet in which the license (NFT) is located to V2. If this wallet address matches that of K to whom the license (NFT) was transferred by V1, authorization is granted and access or procurement can be granted. Otherwise, access can be denied.

Ideally, a license (e.g., NFT) is generated by a module of the device according to the invention. License, token, and NFT can be used synonymously. The license can then be stored (kept) in a suitable electronic (digital) storage medium (crypto wallet (functional), blockchain (technical)). If necessary, the license can be transferred from one storage medium to another. This storage medium may or may not be personalized, i.e., assigned to a specific legal or physical person. The license can also be personalized in this way.

The license (NFT) was previously transferred from a storage medium V1 (e.g., a third-party crypto wallet or NFT trading platform or device according to the invention) to the crypto wallet K of the requester. In order for a device in the sense of a control device (control) to be able to decide on this authorization, a signal, for example in the form of a block, blockchain, a cryptocurrency, or a specific token, must be transferred from the requester's crypto wallet, in which the license (e.g., NFT) is located, from the crypto wallet to this control device (control). In doing so, the wallet address, i.e., the address of the requester's crypto wallet, is also transferred to the control, which is used by the control to evaluate and decide whether the license (NFT) is located in the requester's crypto wallet. In fact, a device according to the invention determines the wallet address directly or indirectly by means of suitable access to a blockchain.

In addition, an identification code that is logically unique to the license (e.g., NFT), preferably the token ID or license ID of an NFT, which is located in the crypto wallet W in the event of actual authorization, is transmitted (optionally) by the requester to the control device (control) directly or indirectly.

Directly means here that the requester transfers a unique identification code (e.g., token ID) to the control (device according to the invention), for example via an input terminal, quasi as a password. Indirectly means that the device according to the invention obtains the unique identification code (e.g., token ID) from the transaction entry in the blockchain, i.e., from the blockchain, through access to it according to the invention, or that it is available, for example, via a database of valid unique crypto values.

In this context, the control or execution of such an authorization means that a decision can be or will be made as to whether such an authorization exists. The device or method according to the invention has a device or, preferably, an electronic method that can determine whether a corresponding authorization exists and, if necessary, grant the corresponding access or the corresponding procurement. The system checks the authorization (e.g., access or procurement authorization) with the aid of a license, preferably in the form of or using a blockchain, which is ideally implemented as a token. This token can be any type of blockchain-based token. Preferably, the unique or unambiguous crypto value (unique token) is implemented as a non-fungible token (NFT), regardless of the basis (e.g., Ethereum, etc.). In order to obtain an entitlement, for example to access or obtain a good or a right, etc., the token (the license) must be located at least in the crypto wallet K of the requester who claims the entitlement, for example by requesting access or obtaining the good or right in accordance with the present procedure. K refers to both the requester and the electronic device assigned to them or the corresponding crypto wallet.

The license (NFT) was previously transferred from a memory V1 to the crypto wallet K of the requester (1 in FIG. 2). In order for the access or procurement system according to the invention to be able to decide on this authorization in the sense of a control device (control), a signal, for example in the form of a crypto value, a crypto currency or a specific token, must be transmitted from the requester's crypto wallet, in which the license (e.g., NFT) is located, to a device V2 according to the invention (2 in FIG. 2). a signal, for example in the form of a crypto value, a crypto currency or a specific token, must be transferred from the crypto wallet to a device V2 according to the invention (2 in FIG. 2). In doing so, the wallet address, i.e., the address of the requester's crypto wallet, is also transmitted to the device, which serves to check whether the license (NFT) is located in the requester's crypto wallet in accordance with the invention.

In a technical sense, no wallet address is transferred; this can only appear to be the case functionally if, for example, part (the receiving part) of the device according to the invention is designed similarly or identically to a crypto wallet. Rather, the device according to the invention determines the wallet address by accessing data in or from entries in the blockchain, which is used here by the device according to the invention as a database.

In addition, in a special embodiment, an identification code that is logically unique to the license (e.g., NFT), preferably the token ID of an NFT as a separate identifier (password), which is located in the crypto wallet K in the event of actual authorization, can be transmitted by the requester to the device (control device, control) directly or indirectly (FIG. 3).

The control device V2 has a device, preferably electronic or digital, for receiving the identification code (e.g., token ID), the signal, and the wallet address from K.

From a functional point of view, information such as the identification code in the form of a token ID, a wallet address, etc. can be transmitted (received, sent) “directly” during the transaction. From a technical point of view, this information is obtained “indirectly” from the blockchain by the device according to the invention.

The control device also has a device that can determine whether the license with the transmitted identification code (identifier) for the authorization (e.g., NFT with the corresponding token ID) is located in the crypto wallet K of the requester who claims the authorization or requests access or procurement. If the identifier is not transmitted, the device checks whether there is a (valid) license in the crypto wallet K. In other words, this device checks whether there is a valid NFT in the crypto wallet K from which the signal was sent to the device (control device). Or, in other words, this device determines whether the NFT (e.g., with the transmitted token ID) is in the crypto wallet whose wallet address was transmitted with the signal to the device (control).

If this is the case, i.e., if the control device determines that the license, e.g., of the NFT, is located in the crypto wallet W of the requester who, for example, claims the corresponding authorization and desires access to a system or the purchase of a good or right, access to the desired system or the purchase of the desired good or right is granted. Only the owner of the crypto wallet from which the signal (crypto value) is transmitted to the control device (control), e.g., in the form of a cryptocurrency, and in which the license representing the authorization, e.g., in the form of an NFT, is located, is identified as the actual authorized party. In other words, in order to realize the corresponding authorization, for example, to access a specific system or to obtain a specific good or right, the NFT representing the corresponding authorization must be located in the crypto wallet from which a signal (crypto value), for example in the form of a specific cryptocurrency or a specific (other) token, is transmitted to V2 (control) to request access or procurement (purchase).

Control V, V3 has a special electronic device that checks whether the NFT or the token ID of the NFT representing the entitlement is actually located in the crypto wallet from which the signal was transmitted to the control with which access or procurement is specifically requested. If an requester transmits the correct identification code (token ID) to the control but the corresponding license (NFT) is not in the crypto wallet from which the signal (e.g., cryptocurrency) was transmitted to the control, there is no authorization and the identification code has probably been transmitted by an unauthorized person, institution, or device. The authorization is then not recognized by the control device (control) and access or purchase is not granted.

However, for sufficient security, it is actually sufficient not to transmit an identification code, as the device checks whether a license (e.g., NFT) is in the crypto wallet and, if so, whether it is valid.

The control device may also use other criteria of its choice to grant authorization, e.g., age, etc. In addition, the control device may have an additional device, e.g., a database that registers, records, or stores how often access or a procurement has been granted, or whether a specified access or procurement quantity has been exceeded.

Many electronic or digital devices are conceivable as control devices, also referred to briefly as “control” in this document. For example, control can be provided via an interface in the form of a web shop or web shop-like interface, whereby the signal can be transmitted in the form of a payment transaction using cryptocurrency, for example. This allows the present invention to restrict the procurement of, for example, certain or regulated goods or rights to authorized persons. The control can also be implemented in the form of an electronic device that monitors or controls access to sensitive locations or objects, such as a safe, a locker, an account, a room, etc. The control can also be implemented at least in part as a crypto wallet or contain such a wallet.

The license can be transferred in the form of an NFT from a central institution, which regulates the corresponding authorizations, directly to the crypto wallet of the requester or made available for purchase on a corresponding platform.

The information that an authorization as described above exists or does not exist can then be transmitted to a corresponding electronic device, preferably in digital form, the authorization or access provider, hereinafter referred to as the provider (device 3). This device can then take the appropriate steps to actually fulfill the requester's request, e.g., the electromechanical opening of a lock.

This can also involve, for example, the shipment of certain products to the requester via an appropriate logistics system, for example, by electronic or postal means. Depending on the application or specific implementation of the invention in question, the provider may be, for example, a manufacturer, a dealer, a supplier, an authority, or simply an electronically controlled door. The provider may also be the producer or distributor of the license (NFT). The requester would be the potential beneficiary of access or procurement, or their electronic device or crypto wallet.

The license may also be limited in time. When the authorization for the requester in whose wallet the license (NFT) is located expires, the token ID of this NFT is simply deleted from the list (database) of valid licenses (NFTs). Ideally, the control system should therefore also have a preferably electronic (digital) database that manages the valid licenses. When the identification code (token ID) is transmitted to the control, the control device can also check whether it is (still) a valid identification code after receiving it. In this way, temporarily valid authorizations could be repeatedly activated or deactivated as required, for example by adding or removing the corresponding identification code (token ID) from the list of valid licenses (database) used by the device (control) to check the validity of the licenses.

The database of valid licenses may be identical to the database of valid wallet addresses or the database of valid unique crypto values.

To illustrate the invention, a specific example of implementation (application) is briefly described below: Suppose that in a certain country, such as Germany at present, cannabis is to be legalized but its distribution is to be restricted to certain social groups and to certain quantities (distribution quantities). To implement this within the scope of the present invention, the requester would be, for example, a consumer who wants to consume cannabis, or whose crypto wallet is K. The requester applies to a distributor V, a suitable authority (company, authority, etc.), for the transfer of an NFT representing the right to obtain cannabis, e.g., a certain quantity per time unit (e.g., 10 g per month). It is conceivable that different NFTs represent different quantities, which may be graded according to the age of the consumer, for example. The appropriate (issuing) entity (distributor) could also make the NFT available on a platform for purchase by the requester. After the NFT has been transferred from device 1 to the requester's crypto wallet, the requester can now proceed to exercise their entitlement by, for example, ordering 10 g of cannabis from the control entity.

The control can be implemented as a web shop where, for example, payment can be made in cryptocurrency for each purchase. The cryptocurrency can be any currency, even one that is generally worthless, such as a special token for this specific type of transaction. This payment process transmits the signal or the address of the crypto wallet to the control. Then, optionally, an identifier, such as the token ID of the NFT representing the authorization, is transmitted to the control via an interface, e.g., via an input mask of the web shop (e.g., copy-paste).

The control has a device that can determine whether there is a valid NFT in the crypto wallet K from which the payment transaction was carried out. If this is the case, the identification as an authorized party is positive. Preferably, a database is maintained for the NFT, which stores each order assigned to this license by date and order quantity to ensure that too much cannot be ordered if there is a monthly order limit or a specific time or quantity access restriction. An advantage of this central ordering process with corresponding authorization determination in accordance with this disclosure is that it ensures that the same quality of cannabis can always be guaranteed due to central quality control.

Another variant would be, for example, controlling access authorization to a locker or safe: The access applicant, for example the renter of a safe deposit box at a bank, acquires (receives) an NFT with a specific token ID from the bank. This is then transferred to the crypto wallet K of the authorized renter of the safe deposit box. If the access applicant (renter of the safe deposit box) access to their safe deposit box, they could, for example, use a local terminal that enables access to the control unit (control) to transmit an identifier (e.g., the token ID of their NFT) to the control and transmit the address of their crypto wallet to the control via a corresponding signal, for example by transferring a special token or a suitable cryptocurrency (crypto asset) from the crypto wallet containing the NFT.

The (direct) transmission of the identifier, which is uniquely linked to the token ID or uniquely encodes it, for example via a terminal connected to the device according to the invention, is optional and only increases the security of the process, as this prevents unauthorized persons who have control over the crypto wallet but do not know the identifier, or persons who know the identifier but do not have access to the crypto wallet, from gaining access. If the identification code or identifier must also be entered as a password via a terminal, for example, it should preferably not correspond directly to the token ID, as this could otherwise be determined from the crypto wallet used and would then not provide any additional security.

Control V2, V3 has a suitable device that is capable of receiving this information electronically and determining whether a valid NFT, optionally with the specified token ID, is located in the crypto wallet from which the corresponding signal was received. If the device determines, using the steps of the method according to the invention, that the NFT is in the corresponding crypto wallet, access can be granted technically by opening the locker, for example by means of an electromechanical mechanism, using a suitable control mechanism. However, if the device determines, using the steps of the method according to the invention, that a valid NFT (license) is not located in the corresponding wallet, access cannot be granted and the safe deposit box remains closed.

Part of a device according to the invention or of the access or procurement system according to the invention may also be an effector that converts the processed information, and in particular whether access or procurement authorization exists in individual cases, into signals that execute corresponding processes in the real world or for the real world.

For example, corresponding software can be started or executed which causes a process in digital or electronic devices, for example access to a computer program or an online service that is relevant for actions in the real world, such as access to a bank account. The device according to the invention can also have a corresponding signal converter (e.g. digital-to-analog converter) that feeds the data determined (calculated) by the access or procurement system into a machine or system control and generates, for example, an electromechanical signal such as a specific electrical voltage to an electromechanical system that executes the access or procurement, preferably to perform a mechanical movement of a mass-bearing object, such as opening a door.

Furthermore, a downstream device is conceivable (possible) as an effector that outputs a signal to indicate the authorization of access or procurement. Such a signal can be any type of signal, such as an electrical, magnetic, electromagnetic, mechanical, electromechanical, optical, acoustic, etc.

Ideally, the license is implemented as an NFT in a “proof of work” network, as this provides almost absolute security. The disadvantage of such networks, namely that the transaction speed is comparatively low and the transaction costs are high, is irrelevant here, since in a preferred embodiment the license is not constantly exchanged (transferred), but essentially only needs to be transferred to the crypto wallet K once, or rarely from one crypto wallet to another.

In the event that the license itself represents the signal that is exchanged with the device according to the invention when access or procurement is requested, it is more advantageous not to use a “proof of work” network should be used, as the transaction speed and transaction costs are an obstacle to the efficient, everyday use of the access and procurement system according to the invention. In these cases, other networks (e.g., Proof of Stake, etc.) would be better suited for representing the license.

The major advantage of this variant is that the signal (crypto value) exchanged between crypto wallet K and the device according to the invention when access is requested is only a “simple” crypto value, i.e. it does not necessarily have to be the license itself, since this signal only serves the purpose of determining the wallet address of K in order to then be able to further analyze whether there is a valid license in this requesting crypto wallet K, i.e. whether K has access or procurement rights. Therefore, absolute security as in the transfer of the license in K using a proof of work network is not required here; instead, another network (such as proof of stake, proof of authority, proof of elapsed time, proof of space, proof of capacity, etc.) that enables fast and cost-effective transactions is sufficient.

For example, an NFT could be executed as a license in the Ethereum network, but the signals between the crypto wallet K and the device according to the invention (device 2) could be exchanged in a layer 2 network of the Ethereum network without “proof of work,” such as the Polygon network. In the event that the license as an NFT also represents the signal that is exchanged with the device according to the invention upon each access or procurement request, such as an admission ticket as an NFT, the license will also preferably not be implemented in a “proof of work” network, but rather in a faster and more cost-effective network.

The embodiment described here is also particularly advantageous for use in memberships or paid services, such as online services, since the licenses that a crypto wallet has or that are organized via a crypto wallet can be displayed in a very clear form in the crypto wallet. A glance at the crypto wallet provides an immediate overview of the licenses managed by the corresponding crypto wallet.

### 3. Embodiment (Token+Wallet Address=License):

In a further embodiment, access to an object or the purchase of a good is further restricted or specified (personalized) compared to the previous variants by additionally including a database with valid wallet addresses by adding to the criterion already described of a valid unique crypto value in an requesting crypto wallet, in the event of the transfer of any crypto value from the requesting crypto wallet to the device according to the invention or the transfer of a valid unique crypto value from the requesting crypto wallet to the device according to the invention, the criterion that that this transfer must be made from a valid wallet address.

This is therefore a combination of the two previous embodiments. If this situation is compared again with an admission ticket, the admission ticket would be personalized. This would typically be the case, for example, with an airline ticket, where only the person named on the ticket is entitled to fly. In this embodiment, as in the above, a database of valid unique crypto values is maintained in addition to a database of valid wallet addresses. Thus, when a valid unique crypto value is acquired from an issuing entity, which may also be the device according to the invention, a corresponding entry of a corresponding identifier is made in a database of valid unique crypto values by transfer to a crypto wallet, thereby also entering the wallet address of the acquiring crypto wallet in a database of valid wallet addresses.

In a variant (of this embodiment), the (requesting) crypto wallet that desires access to an object or the purchase of a good exchanges a fundamentally arbitrary crypto value with a device of the system according to the invention using a blockchain in a manner according to the invention. After the wallet address of the crypto wallet that exchanged the crypto value with the device has been determined in accordance with the invention, as already described, a separate device, which preferably performs a suitable analysis of data in or from entries in the blockchain, determines (detects) whether at least one unique crypto value (token, e.g., NFT) is located in the requesting crypto wallet. (entries), whether at least one unique crypto value (token, e.g., NFT) is located in the requesting crypto wallet. If this is the case, the device of the system or a specific module of the device determines the unique identifier or identification (TokenID) from the unique crypto value or values. The device according to the invention or a corresponding module thereof then determines whether the identifier or identification of the unique crypto value (token, e.g., NFT) detected in the requesting crypto wallet (TokenID) is found in the database of valid unique crypto values. If this is the case (TokenID=LicenseID), i.e., the identifier or identification of the unique crypto value (token, e.g., NFT) detected in the requesting crypto wallet is found in the database of valid unique crypto values, then one of the two criteria necessary for access to the object or for obtaining the goods in question is considered to be fulfilled. Furthermore, the wallet address of the requesting crypto wallet is compared with the entries in a database of valid wallet addresses. If the wallet address of the crypto wallet is found in the database, the second of the two criteria for access to the object or for obtaining the goods in question is also considered to be fulfilled. If both criteria are fulfilled, whereby the order in which the two requirements are determined is irrelevant, access is granted or the goods are made available. The further technical implementation of this release proceeds as already described.

In a further variant of the embodiment, the requesting (access or procurement requesting) crypto wallet, i.e., the crypto wallet that desires access to an object or the procurement of a good, transfers a unique crypto value (e.g., NFT) to the device according to the invention. The device according to the invention then determines the identifier or token ID of the unique crypto value and compares it with the entries in the database of valid unique crypto values.

If the identifier (token ID) matches an entry in the database of valid unique crypto values, one of the two criteria for granting access to a (specific) object or the purchase of a (specific) good is considered to be fulfilled. Furthermore, the wallet address of the requesting crypto wallet is determined and compared with the entries in a database of valid wallet addresses. If the wallet address of the crypto wallet is found in the database, the second of the two criteria for access to the object or for obtaining the goods in question is also considered to be fulfilled. If both criteria are met, whereby the order in which the two requirements are determined is irrelevant, access is granted or the procurement is enabled. The further procedure or the further options then correspond to those already described for the case where the criterion is met.

In a further variant of various embodiments, the requesting party, i.e. the party seeking access or procurement, transfers an identifier representing a unique crypto value to the device according to the invention, not via the communication channel used by the crypto wallet seeking access or procurement to communicate with the device according to the invention, but via a second, independent communication channel. This can be done, for example, by manually entering a corresponding password (identifier) at a terminal. The password can be arbitrary or part of the token ID of the unique crypto value. It can also be encrypted end-to-end. In any case, the device according to the invention must also have a corresponding database for identifying the password as a valid password.

In addition to the primary identifying communication between the crypto wallet and the device according to the invention through the exchange of crypto values, the party requesting access or procurement also transmits information to the access or procurement system or the device according to the invention via a suitable interface. This information can be of any kind. For example, a character string of any length, biometric information, information from a two-factor identification from an SMS, identifier, etc. It is important that the identifier via two-factor identification is not received on the same technical device on which the crypto wallet is running.

If the primary identification resulting from the communication between the crypto wallet and the access or procurement system or the device according to the invention by exchanging crypto values was successful, it is ensured that the party that has control over the crypto wallet is authorized to access or obtain the crypto values. Since this control generally only exists for the actual owner of the crypto wallet, provided that they handle the private key with care, it can also be assumed that this is the party who is legitimately seeking access or withdrawal. By transmitting additional information that comes directly from the party requesting access or withdrawal, it is possible to further increase the probability that the person controlling the wallet is the truly authorized party. In addition to checking the access or withdrawal authorization by exchanging crypto assets between the crypto wallet and the access or withdrawal system according to the invention, it is also checked whether this additional information, which is transmitted separately from the party requesting access to the device according to the invention via a further communication channel, is stored in a further database according to the invention, which contains the corresponding valid identifiers. Preferably, this database does not directly contain the identifier (TokenID) of an (exchanged) unique crypto value or the wallet address of the requesting crypto wallet, but rather an identifier indirectly linked to it via a database.

If, for example, the requesting party passes this identifier on to the access or procurement system, a suitable device according to the invention checks whether this identifier is in the corresponding database of valid identifiers according to the invention or not, and if so, with which valid unique crypto value or with which valid wallet address this identifier is linked and whether these match those (valid unique crypto value or wallet address) that have proven their access or procurement authorization via communication between the requesting crypto wallet and the device according to the invention by exchanging a crypto value. The further release procedure, if all criteria are met, is as described above.

### 4. Embodiment: Access to Premises

Another embodiment relates to controlling physical access to one or more rooms using an access system according to the invention (FIGS. 1, 2). This could be access to a house (e.g., a residential building), an apartment, an office, a sensitive area (laboratory, vault, etc.), etc. Here, access can be controlled either fully automatically or only semi-automatically. However, the embodiment is shown as a general example and the components and functions described are not limited to this application, but are applicable to all forms of application.

In the semi-automated version, access is physically granted by an authorized person on the basis of an authorization check using a device according to the invention. The authorized person has a device according to the invention or access to a function of a device according to the invention, which is available at the access location in a stationary or mobile form.

For example, the device can be designed with an interface for communication, i.e., the exchange of information, for example in the form of an app on a mobile phone (cell phone, smartphone, or other electronic “handheld device”) or a functionally equivalent stationary version, which enables the exchange (transmission) of relevant information with the requesting crypto wallet, which is required for the transaction, i.e., for the exchange of a signal (e.g., cryptocurrency) for the purpose of requesting access between the access-requesting crypto wallet and the device according to the invention and the determination of access authorization with the aid of a blockchain.

Preferably, the device according to the invention provides this information by means of a suitable interface (e.g., screen, Bluetooth, digital line, etc.) in a suitable code (e.g., QR code) on a screen for reception by the device executing the crypto wallet or physically represented in such a way that it can be transmitted to the crypto wallet or the device on which the crypto wallet is executed via a suitable interface of this device (e.g., camera, Bluetooth, digital line, etc.) to the crypto wallet or the device on which the crypto wallet is executed.

In addition, the device requires a connection to a blockchain network, preferably via an Internet connection, in order to exchange a signal (crypto value) with a crypto wallet requesting access or procurement. Functionally, a signal in the form of a crypto value is exchanged between the access-seeking crypto wallet and the device according to the invention, or the crypto wallet transmits a crypto value to the device according to the invention. The information about the wallet address or the identifier (TokenID) of a unique cryptocurrency (e.g., NFT) can also be transmitted directly or indirectly. However, the data or information exchange can also take place in the opposite direction.

Technically speaking, control over the “transmitted” crypto value (signal) is transferred from the crypto wallet to the device according to the invention or vice versa, and the data relating to this transaction is stored via an entry in the blockchain. The device according to the invention then determines (generates) from data in or from entries in the blockchain (database), for example with the aid of a suitable module according to the invention (sub-device), which allows access to the corresponding entries in the blockchain that are necessary for determining access authorization, the data relevant for access authorization, such as the wallet address of a crypto wallet (in particular the crypto wallet requesting access or the one involved in the transaction) or the identification (identifier, token ID) of a unique crypto value (NFT) (in particular the token ID of that unique crypto value (NFT) located in the crypto wallet requesting access). If access is granted to the access-seeking crypto wallet (or the person who has access to this crypto wallet) by the access system according to the invention, a corresponding indication is given by the device according to the invention (e.g., a green light (LED) lights up). The authorized person can then physically grant access to the requesting person and open the door.

In the fully automated version, the device also has a device (invention-related sub-device, module) which technically executes the release of access to the premises and thus automatically opens the access-restricting door physically without the need for an authorized person to do so. This can be achieved, for example, by the device according to the invention or the associated interface for communication or the exchange of transaction-relevant information (data) between a crypto wallet and a device according to the invention being preferably not mobile but stationary. The crypto wallet is usually physically organized via a mobile device (e.g., smartphone).

It is conceivable that a corresponding interface for communication between the device according to the invention and a crypto wallet requesting access is installed in the door or on or in the wall next to the door or near the door that blocks access. Preferably, this is achieved by installing a screen, preferably made of shatterproof glass or similar materials that are transparent to visible light, in front of the device and protected from direct physical influence. However, if communication takes place in the opposite direction, a camera may be used.

If an access seeker wants to get into the rooms blocked by the door, the screen (camera) can be activated to show (read) the communication data as soon as the seeker gets close to the interface, for example, with a motion detector or an infrared detector. Preferably, the device according to the invention provides this information by means of a suitable interface (e.g., screen, Bluetooth, digital line, etc.) in suitable coding (e.g., QR code) on a screen for reception by the device that executes or physically represents the crypto wallet, so that it is available for communication with the access seeker. etc.) in a suitable code (e.g., QR code) on a screen for reception by the device that executes or physically represents the crypto wallet, so that it can be transmitted to the crypto wallet via a suitable interface of this device (e.g., camera, Bluetooth, digital line, etc.).

It is also conceivable that the display of the coded information can be actively triggered by the access applicant not by means of an infrared detector, but by operating a switch or push button or similar. After access authorization has been determined, instead of or in addition to a display (e.g., green light, acoustic signal, etc.), an effector is activated which transmits a suitable signal to a preferably electromechanical device, which thereby activates an electromechanical mechanism which opens the door lock or the door is opened. etc.), an effector is activated which transmits a suitable signal to a preferably electromechanical device, which thereby activates an electromechanical mechanism that opens the door lock or mechanically moves the door, thus allowing access to the premises.

In principle, the exchange of information via the interface can take place using any technical form of communication. Signals via visible light (QR code) or light of a different wavelength (e.g., infrared, microwave, etc.), via connection to electrical lines or light guides, etc., are conceivable.

In a special variant, the crypto wallet can also be part of the device according to the invention, and the exchange of information can also take place via a very special, particularly secure connection between the crypto wallet and the device with which the information (signal, crypto value) is exchanged.

It is also conceivable to implement access hierarchies, i.e., different access authorizations. For example, access to different rooms can be granted with one and the same license, or certain licenses with their access authorization can be restricted to certain rooms. Different licenses can be represented by different unique crypto values (NFT) or by different wallet addresses. Different access to rooms can be regulated, for example, by an entry in a database of valid unique crypto values or a database of valid wallet addresses, which either exists for each access (door) or, if a database of valid unique crypto values or database of valid wallet addresses for managing an ensemble of multiple accesses, is additionally linked to one or more entries in a database that manages the corresponding doors (accesses).

If, after exchanging a signal (crypto value) in the access-seeking crypto wallet, the device according to the invention finds a unique crypto value (NFT) with a specific identification code (TokenID), e.g., 4711, the device according to the invention checks whether this identification code is found in the database of valid unique crypto values for this access (door). In this way, each access has its own database of valid unique crypto values or, if the wallet address represents the license, its own database of valid wallet addresses. If this is the case, access can be granted.

If access authorization is determined by checking an entry in a database of valid unique crypto values or a database of valid wallet addresses that applies to a set of multiple access points (doors), the device according to the invention checks which doors (access points) the identification code is linked to in the database of valid access points. If the door or a suitable code for the door to which access is requested is found in an entry in the database of valid accesses linked to the entry of the identification code (TokenID) in the database of valid unique crypto values or database of valid wallet addresses, access is granted to the corresponding door.

If there is a separate database of valid unique crypto values or database of valid wallet addresses for each door and each door exists as an independent entity within the meaning of the invention, the identification code (TokenID, LicenseID) must be located in each database of valid unique crypto values which is assigned to a door (access) to which the requesting crypto wallet has access rights.

In this way, corresponding access hierarchies can be created. For example, if a specific NFT is linked to each door (access) or is located in the databases of several doors, it can represent a kind of master key that grants universal access to a facility consisting of several rooms that are locked with doors. At the same time, access can be restricted to only certain rooms.

### 5. Access to Cars From a Specific Car Fleet (Car Sharing):

Similar to the regulation of access to premises, in a specific embodiment, access to cars or the use of cars from a specific car fleet, for example for a car sharing model, can also be regulated in accordance with the invention. It is conceivable that an interface for exchanging information in preparation for a transaction, as already described, could be installed in or on the cars of this fleet, for which a usage authorization is granted to users or access applicants. The transmission (e.g., display of a QR code, screen, etc.) or reception device (e.g., camera) of the device according to the invention for exchanging information via the interface in preparation for the transaction can be activated in various ways. It is conceivable that any signal, such as an acoustic, optical, mechanical, electrical, or electromechanical signal, could be transmitted directly or indirectly (e.g., via an app) to the interface or device according to the invention. For example, a screen may be mounted behind the windshield of the car to display a QR code that represents certain data required for the transaction and can be read accordingly by a crypto wallet or a suitable device connected to it. This display can be activated in the manner described above, for example. After this information has been exchanged via the interface, a crypto value, preferably in the form of a specific amount of a cryptocurrency, can be exchanged during the transaction between a requesting crypto wallet and the device according to the invention. Preferably, the crypto wallet transfers a specific amount of a cryptocurrency to a device according to the invention. Then, in the manner already described according to the invention, it is determined whether authorization for access to the car or for use of the car exists. This again requires a corresponding registration process according to the invention, in which the wallet address of the requesting crypto wallet is entered into the database of valid wallet addresses or the token ID (or correspondingly derived identifier) is entered into the database of valid unique crypto values.

If the license (authorization) is in the form of a unique crypto value (e.g., NFT), the acquisition of this unique crypto value can already be considered as the purchase of the basic authorization (of the NFT), for example, by transferring a certain amount of a cryptocurrency from the crypto wallet to the device (e.g., V1, S1, etc.) in exchange for the transfer of the unique crypto value to the crypto wallet. With this license in the crypto wallet, the party acquiring access can request and, if necessary, obtain access to the car and use of the car via a corresponding transaction (transfer of a signal in the form of a certain amount of a cryptocurrency as access fee). It is conceivable that at the end of the journey, the driver or authorized person completes the process via a further transaction and transfers the costs incurred by the car or a suitable device assigned to the car in accordance with the invention by transferring a further amount from the crypto wallet to the device in accordance with the invention. This can be done, for example, after getting out and closing the doors using the same interface as at the start of the journey.

### 6. Embodiment: Procurement System With Commission Evaluation:

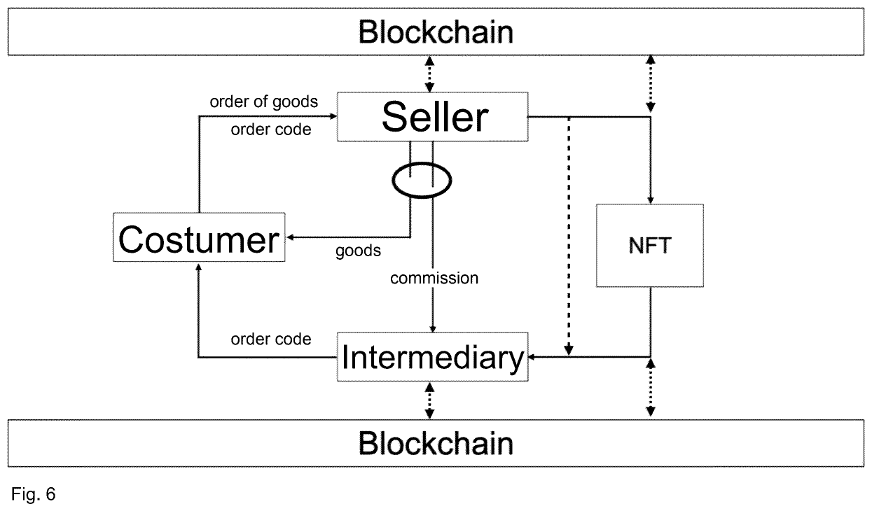

In a further embodiment, commission fees for the purchase of goods can be automatically recorded, allocated, calculated, or transferred by means of an access or procurement system according to the invention (FIGS. 6, 7, 8, 9, 10, 11, 12). The seller of a product or good is represented by a procurement system according to the invention. This generates a unique crypto value (e.g., NFT) with an identifier (TokenID). The unique crypto value is transferred directly or indirectly (e.g., via a platform where the crypto value can be purchased for money) to the crypto wallet (intermediary) K entitled to receive a commission payment, and the TokenID is entered into the database of valid unique crypto values in a registration process (registration). The token ID is then a license ID that represents the corresponding entitlement to a commission payment. If an intermediary now brokers a product (good) to a customer, they directly or indirectly transmit an order code to the customer, which preferably corresponds to the token ID or encodes it in some way that is unique and represents the unique crypto value located in the intermediary's crypto wallet K.

If the customer now orders goods from the seller via the device V2 according to the invention, specifying the order code, for example by entering it in a corresponding mask in an online shop, because he receives a discount on the purchase by specifying the order code, a corresponding device of V2 of the procurement system according to the invention uses a database of valid unique crypto values according to the invention to determine whether the transmitted order code is actually a license ID, i.e., a valid NFT. If this is the case, the device V2 according to the invention can determine the current wallet address of the crypto wallet in which the unique crypto value (NFT) is located at the time of the purchase transaction by accessing data in or from entries in a blockchain and analyzing the data in a suitable manner. In a special variant of the embodiment, the commission is then transferred to this crypto wallet, preferably automatically, in the form of a cryptocurrency. However, the commission can also be transferred to the intermediary in the conventional manner (e.g. bank transfer) if the necessary data are available in the procurement system according to the invention.

However, since a license can be transferred from the license holder (crypto wallet n) to another crypto wallet (crypto wallet n+1), another variant of the embodiment provides that, when registering the procurement applicant (intermediary, crypto wallet K), the wallet address of that crypto wallet is also recorded in a database and preferably linked to the token ID that had the unique crypto value (e.g., NFT) at the time of registration. If a customer now purchases goods by specifying the corresponding order code and it is determined by a suitable device of the procurement system according to the invention that the current wallet address determined with the aid of data in or from entries in the blockchain, which has the unique crypto value (NFT), does not match the registered wallet address in the corresponding database of the procurement system, there are various options for making a decision.

On the one hand, the commission can be transferred to the registered crypto wallet (or to it by conventional means if the relevant data (name, bank account) is known) or to the current one. In any case, it is necessary to manage a dynamic database, also with the help of the blockchain, through the procurement system according to the invention in order to be able to determine which crypto wallet has had a license for a specific unique crypto value (NFT) in the past and which currently has it, and whether it is registered in the procurement system at all.

In one variant, a license L is created which establishes rights to a real-world asset. This license is then represented as a blockchain, e.g., as a token, which has its own, preferably unique, electronic (e.g., alphanumeric) identification, the license ID (e.g., token ID, TokenID) (LID). This can be done, for example, on an Ethereum-based blockchain, e.g., in the form of a non-fungible token (NFT). However, any other basis can be used. For example, a token is created (minted) to which a license is assigned or which represents a license. In the case of an NFT, a specific license, e.g., license No. 4711 (LID), which may differ in its content (rights) or value or by another characteristic such as the number of sales of a good, the value of a real estate or land share or a real estate or land from other licenses, to a specific NFT, e.g., NFT No. 4711 (LID). Generally speaking, a token ID (token identification) of an NFT is uniquely assigned a LID according to token ID =f(LID) (token ID is a function of the LID), whereby these do not have to be identical but are uniquely assigned (function definition). TokenID, LicenseID, TID, and LID are therefore used synonymously in this document, unless otherwise specified.

The textual content of the license, which describes how and under what conditions the license establishes a right to a real-world asset, can be attached to the token as text or posted somewhere on the Internet for general viewing or for viewing only by the token holder. Throughout this document, the terms license, token, unique crypto value, or NFT, which can represent the license, are used synonymously unless otherwise specified.

The procurement system according to the invention technically maps the following processes and sequences by means of corresponding devices or modules or executes them technically (technical processes): The license Lm (the mth license) is generated directly or indirectly by the issuer (seller) V1 of the license, which is represented accordingly as a crypto value (mined, minted). For the sake of clarity, Lm is also referred to as L in the following. The license is then stored (saved) in a suitable electronic (digital) storage medium S, preferably in the blockchain. Throughout this document, the terms electronic and digital are used synonymously unless otherwise specified. Ideally, the storage medium S (preferably a crypto wallet) also allows the license to be transferred to another storage medium under certain conditions with the help of the blockchain, e.g., to a suitable crypto wallet. V1 can use an electronic device (EDP) or an electronically supported process with corresponding process steps or software (P) to store the license in S. For example, P can be an electronic platform (EDV) for generating, storing, and trading NFTs (trading platform) with the help of the blockchain. For example, V1 preferably mints an NFT on P and offers it for sale on P to a potential buyer K1. For the sake of clarity, the terms K1 and K2 are also used in this document to refer to the first and second owners Km1 and Km2 of the license Lm, and simply L for Lm when referring to a basic description. However, K1 preferably refers to Km1, K2 preferably to Km2, Ki preferably to Kmi (in general), and L preferably to Lm. Depending on the context, Ki can therefore describe the wallet in which the i-th license is located or the wallet of the i-th owner with a specific license. This follows from the logical context. However, Ki preferably describes the i-th wallet in which a license is located, unless otherwise specified. K is also generally used for any wallet. The NFT with the corresponding TokenID then naturally represents the license L or Lm. If the buyer acquires the license Lm with the crypto wallet K1 (Km1), this is done by transferring Lm from V1 or S or P to the crypto wallet of K1, i.e., the crypto wallet Km1. Preferably, a sum of money in the form of a cryptocurrency is also transferred from the crypto wallet K1 to the crypto wallet or the device according to the invention V1. Preferably, the right to the good established by L and exercised by the owner of L, namely K1, includes the right to broker the purchase of a good from the seller of the good V2 by a (potential) buyer KG and to receive a commission from the seller V2 for this. The owner of the license is equated (synonymous) in this document with the crypto wallet in which the license is located. The crypto wallet is the technical representation of the ownership of the license. In order for KG to be able to carry out the legal transaction (purchase of the goods) through the mediation of K1, i.e. to be able to purchase (acquire) the goods at least under certain conditions, KG requires an order code C that uniquely identifies K1 as the intermediary or owner of L. K1 therefore transmits the order code C directly or indirectly, preferably by electronic means, to KG. KGp is the pth buyer of a good that is the subject of the process or the pth crypto wallet involved in this process. The order code can, for example, be the crypto wallet address of K1 or that of the crypto wallet in which L is currently located, or the token ID of the license L (license ID), or any other coding that is suitable for uniquely identifying K1 as the intermediary in the legal transaction between KG and V2.

Indirectly means, for example, that K1 has stored the code C somewhere on the Internet in such a way that KG can transmit it directly or indirectly to V2 for its purchase of the goods from V2. In addition to C, KG preferably transmits the following data to V2 for the purpose of processing the purchase of the goods: Name and delivery address, possibly the quantity and type of goods he wishes to purchase, and ideally an email address or other electronic communication address to which an order or purchase confirmation can be sent. The data is preferably transmitted to V2 electronically, e.g. via the Internet. This is preferably done by transferring the data from a suitable (electronic) form in a web shop via the Internet from KG to V2. In this context, a sum of money G representing the purchase price of the goods that KG is purchasing from V2 can be transferred, for example, in the form of a cryptocurrency from the crypto wallet KG to the crypto wallet V2. To do this, V2 can send KG the address of the crypto wallet V2, i.e., V2 provides KG with the address of the crypto wallet V2, preferably as a code (e.g., QR code) on the V2 website or the associated web shop.

Furthermore, a partial amount TG is then transferred by G in the form of a cryptocurrency to the crypto wallet K1 as commission for brokering the sale of the goods from V2 to KG by K1. However, TG can also be transferred to any conventional bank account or a comparable institution in fiat money or other currency. The transfer of this partial amount TG from G to the crypto wallet of K1 is preferably carried out from the crypto wallet of V2. However, TG can also be transferred to any conventional bank account or comparable institution in fiat money or other currency. Once these processes have been successfully completed, an electronic order is sent electronically to the shipping logistics department to ship the goods, the technical execution of which may be part of the procurement system according to the invention.

K1 can also transfer L to another crypto wallet, e.g. K2. K2 thereby assumes all rights to the goods established by L and previously exercisable by K1. In particular, K2 thereby replaces K1, preferably completely, in relation to KG, V1, and V2. In a special embodiment, however, the transfer of TG to Ki can be technically executed in such a way that at least part of TG continues to be transferred to at least one of the previous owners of L, i.e., to at least one other wallet Kj with j<i, in which L was previously located. However, since KG, depending on the embodiment, is not aware of the change of L between K1 and K2, it will continue to transmit the order code C known to it, which it received from K1, to V2 in subsequent purchases of the good. Since V2 initially continues to assign the order code C to the address of the crypto wallet K1, V2 would continue to transfer TG to K1 without knowledge of the transfer of L from K1 to K2, even though K2 is now the legal successor of K1 and all TG are due to it. To prevent this, either K1 or K2 must inform V2 about the transfer of L from K1 to K2. However, this then raises the problem that V2 must verify whether this information is actually correct, i.e., whether L is really only in wallet K2. This is then carried out (determined) in V2 by a module (EDP) which, before a transfer of TG from V2 can be carried out, uses access to the blockchain (database) with a suitable module (device) according to the invention to determine in which wallet L is now actually located.

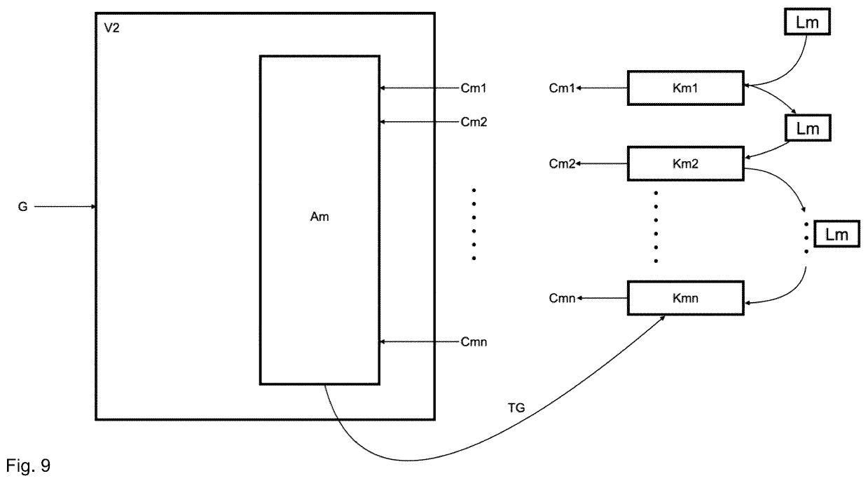

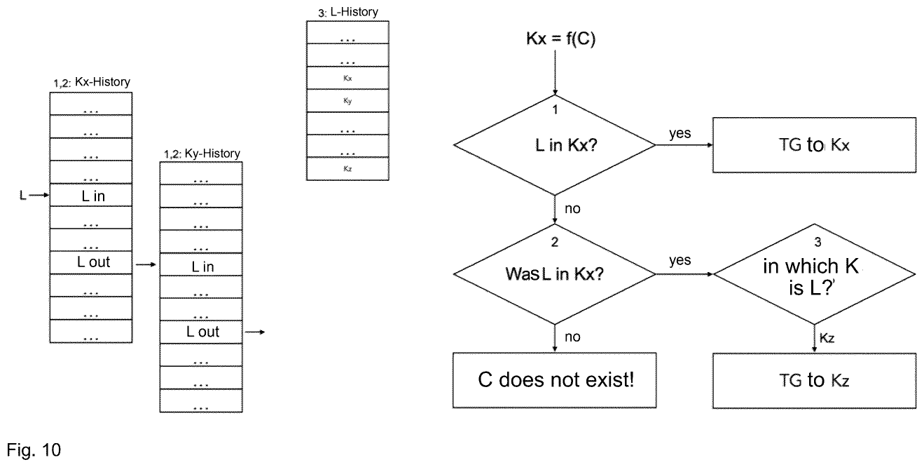

In a variant of the embodiment, the order code C will be assigned to the crypto wallet K in which L is located (FIGS. 9, 10). If Lm has already changed owners n−1 times, i.e., has been transferred from one wallet to another n−1 times, Lm is now located in wallet Kmn. However, each wallet Km in which Lm has been located once (which had control over Lm in the blockchain) is assigned a unique order code C (Cm1 to Cmn). In this case, the order code C simply represents the address of the wallet K in which the license L is located. Then V2 only needs to transfer the amount TG directly to C, since C=K. However, if a customer KG is not informed about the transfers of Lm from one wallet to another, they will continue to use the order code they know, for example Cm2, which is assigned to the wallet Km2, even though the current order code would be Cmn and TG would have to be transferred to Kmn. V2 cannot rely on Km1 to Kmn informing V1 of the transfer of Lm from one wallet to another. To prevent TG from being transferred to Km2 by mistake, a module is provided that uses the blockchain to determine beyond doubt which wallet Lm is currently in and to which wallet (Kmn) TG must be transferred as commission.

If KG now transfers the order code C (e.g., Cm2) to V2, the currently associated crypto wallet (wallet address of the crypto wallet) K (e.g., Km2) must first be found (Km2=Kx=f(C). Ideally, C (e.g., Cm2) directly represents the wallet address K (e.g., Km2), in which case Km2=Cm2. Now it must be clarified whether L is still in K, i.e., whether Lm is still stored in wallet Kx (e.g., Km2) or has been transferred to another wallet. For this purpose, a “Kx history” database must be available, which can store the history of (every) suitable wallet that can store the licenses, i.e., this type of token or their unique identifier or identification (TokenID), with regard to the licenses L (e.g., tokens or NFTs) and which allows V2 to access and read (determine) whether a license or a specific license (e.g., Lm) is or has been in one of the wallets Kx or in a specific wallet (e.g., Kx or Km2). This is preferably done using an apparatus according to the invention, which performs this task at least in part with the aid of an “external” database or memory, namely the blockchain.

If L (e.g., Lm) is located in Kx (e.g., Km2), then TG is transferred from V2 to Kx (e.g., Km2). If L (e.g., Lm) is no longer located in Kx (e.g., Km2), the question arises as to whether any license was ever located in Kx (e.g., Km2). If this is not the case, KG transferred a non-existent order code C to V2. However, if this was the case, i.e. a license L was once in Kx but was later transferred to Ky, for example, and therefore no license is now in Kx, this license must be identified, i.e. the license ID or token ID must be read out by a device according to the invention in V2 from the K history database “Kx history” (e.g. “Km2 history”).

This is preferably done using a device according to the invention, which performs this task at least in part with the aid of a suitable database or memory, namely the blockchain. In order to determine in which wallet L (e.g., Lm) is currently located, i.e., to which wallet TG from V2 is to be transferred, an L history database “Lm history” must be available, which contains the history of those wallets in which the license L (e.g., Lm) has ever been located. Preferably, this is done using an apparatus according to the invention, which performs this task at least in part with the aid of an “external” database or memory, namely the blockchain. V2 must read from a corresponding database (blockchain) in which wallet L (e.g., Lm) is currently located, i.e., Kz (e.g., Kmn). V2 now transfers TG to Kz (e.g., Kmn). Now it is necessary to distinguish the case where several licenses L are located in a wallet K. In this case, even if one of its licenses is transferred from wallet K to another wallet, K will receive the TG assigned to its wallet K via C.

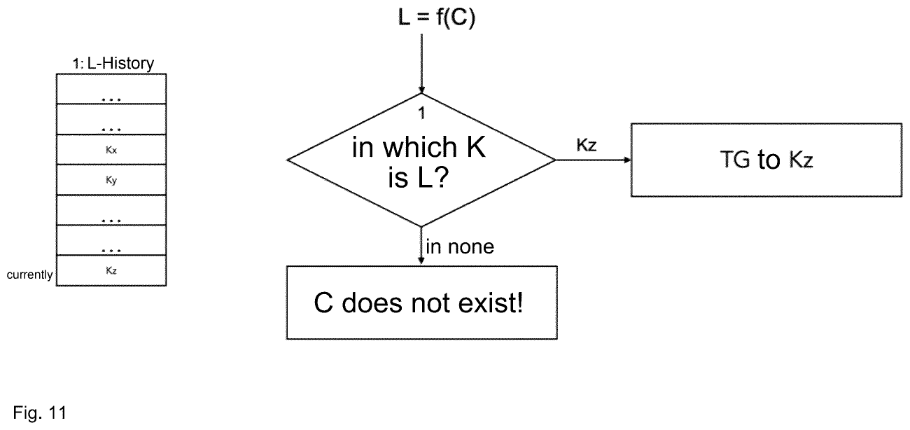

It can be seen that assigning the order code C to the wallet K in which the license L is currently located is relatively complicated. Therefore, in a further variant of the embodiment, it would be simpler not to assign the order code C to the wallet containing the license L, but to the license L (FIG. 11):

In a further variant of the embodiment, the order code C is assigned to the license L by a device according to the invention, whereby L=f(C) or C=f(L), L is a unique function of C or vice versa. The simplest way to do this would be to use the token ID as the order code C, i.e., C=license ID or token ID or C=f(token ID) or C=f(license ID). In order to determine in which wallet K L (e.g., Lm) is currently located, i.e., to which wallet TG is to be transferred from V2, a database “L history” must be available, which contains the history of those wallets in which the license L (e.g., Lm) has ever been located. This is preferably done using a device according to the invention, which performs this task at least in part with the aid of an “external” database or memory, namely the blockchain. V2 must read from the database in which wallet L (e.g., Lm) is currently located, i.e., Kz (e.g., Kmn). V2 now transfers TG to Kz (e.g., Kmn). Finally, the license L must be evaluated when it is transferred to another crypto wallet. This depends on how many purchases of the good were made by V2 from KG through the previous owners of license L (e.g., Lm). In other words, how much TG was transferred by V2 to the crypto wallet in which a specific license (e.g., Lm) was previously held. With the transfer of L from Ki to Kj, a customer base is also transferred, namely those customers who regularly purchase or order the good using the codes (e.g., TokenID) assigned directly to the license C(L)=f(L) or indirectly via the wallet C(L)=f(L=f(K)).

In the case of independent commercial agents, it is customary that when they leave their job, they receive a certain percentage of the sales they generated from the company they worked for. Their successor usually takes over the customer base (existing customers) of the departing commercial agent, but does not have to pay a transfer fee for taking over the customer base of their predecessor.

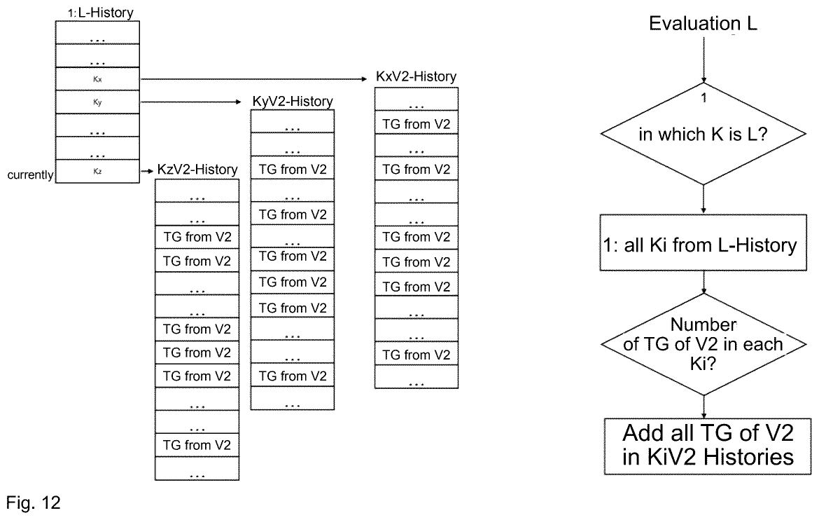

A potential buyer who wants to acquire the Lm license from Kmn, i.e., transfer it from Kmn to the possible future Km, n+1, needs an assessment to decide what value Lm has—e.g., how much potential commission payments they can already expect based on Kmn's activities with Lm. The “K history” and “L history” databases discussed above, even though they are based on blockchain, are not very helpful in this regard (FIG. 12), since it is not clear, especially if a wallet K contains several licenses L, which licenses the “TG from V2” came to K via.

It is therefore proposed to provide, preferably in the device according to the invention in V2, an L-TG history database in order to be able to evaluate a license L. This contains all TG transfers from V2 to all Ki wallets (e.g., Kij) in which the license Li has ever been located. Kij is then the jth crypto wallet in which the ith license is or has been located. This data (transfers from TG to Ki wallets) is then read out by V2 and preferably made available transparently to all or to those interested in purchasing the ith license.

In another embodiment, the data from the L-TG history can also be made available selectively to certain elements of the system. It is clear that KG and TG are the general representation of the (probably many) buyers of the good (e.g., KGr) and the (probably many) transfers (e.g., TGs). The same applies to the transfers G (e.g., Gs). The use of the K history databases and the L history databases according to FIG. 12 only offer the potential Km, n+1 the possibility of estimating whether the L-TG history database can be correct (verification). The L-TG history database is an element of a license evaluation module as part of the procurement system according to the invention and is preferably implemented via access to the blockchain by this evaluation module.

Ideally, the K history databases, the L history databases, and the L-TG history databases are electronic databases that are dynamically organized and automatically update themselves at any time or at specific intervals (e.g., periodically) and are at least partially organized in the blockchain.

An assignment module assigns the order code C transmitted by KG to V2 to the wallet K in which the license L, which establishes the right to broker the sale of the goods from V2 to KG, is located and to which an amount TG is transferred by V2.

An evaluation module determines the current value of the license L. This is done by representing the sum of the amounts of money TG transferred by V2 to all wallets K in which the license L has been located (at a specific point in time) up to that point. This value can also be determined selectively by the evaluation module for a specific wallet in which the license L has been located or is currently located.

The technical device for executing the processes (process steps) according to the invention enables or has, directly or indirectly, at least one electronic connection between two of the components V1, S, P, K (e.g., Kij), KG, V2 and/or between two of the components K with each other (e.g., Kij with Klm, where i is not equal to I and/or j is not equal to m). Kij means the jth crypto wallet in which the ith license is or was located. If there are M existing licenses, i is less than or equal to M, and if there are N crypto wallets in which the license was located, j is less than or equal to N. A direct connection means that the information is transmitted directly from one end of the connection to the other end of the connection. An indirect connection means that the information is first stored temporarily or permanently in a buffer between the sender and recipient of the information before it finally reaches the recipient.

The good that can be obtained via the procurement system according to the invention can be anything, e.g., a beverage produced by a manufacturer and sold for a certain amount G. The manufacturer has an electronic infrastructure (device, IT system) V2 with or and a crypto wallet via which payments can be made using a cryptocurrency to holders of an NFT (K) (crypto wallet K in which the license (NFT) is located) and can be received by customers KG (wallet KG), an electronic device via which a potential buyer of the goods can transfer data to V2 for the purpose of ordering or purchasing the goods using their electronic infrastructure KG, and an electronic device (EDP) with which V2 can identify, analyze, or document NFT transfers in or from a specific crypto wallet (K history database) and/or with which V2 can identify, analyze, or document in which crypto wallet a specific NFT is currently located or in which crypto wallets a specific NFT has been located in the past (L history database) and/or which transfers from TG to wallets K, in which L was located in the past and in which L is now located (L-TG database). This electronic infrastructure (EDP) is also used to transfer the address of the crypto wallet V2 to KG and the order code, preferably in the form of the token ID of the NFT of the intermediary K from KG to V2. V2 and V1 may be identical, i.e., only one device or logical unit.

At least two of the following steps are performed by devices according to the invention of a procurement system according to the invention. They do not necessarily have to be performed in a specific order:
a unique crypto value (e.g., NFT), preferably with a specific and unique token ID, is generated (minted) by the seller, V1, S, or P
a unique crypto value (e.g., NFT) is stored, preferably in a device S according to the invention, P, V1, or seller
a unique crypto value (e.g., NFT) is transferred by S, P, V1, or seller to a crypto wallet K
an amount in cryptocurrency is transferred from the crypto wallet K to V1, whereby V1 has preferably provided K, directly or indirectly, with the address of the crypto wallet V1 beforehand
K has an order code C which preferably corresponds to the token ID of the NFT or is uniquely linked to it, which is located in the crypto wallet K
K provides KG with the order code C by making it available to KG on the Internet, preferably electronically, and/or transmitting it directly to KG by electronic means
KG transmits the order code C to the device V2 according to the invention, preferably together with other data such as name, address, email, telephone number, address of the crypto wallet (wallet address) KG
V2 provides KG with the address of a crypto wallet belonging to V2
An amount G is transferred from the crypto wallet KG to a crypto wallet belonging to V2
V2 identifies (determines) the wallet address of the crypto wallet K to which the order code C belongs, preferably by determining in which crypto wallet K the unique crypto value (e.g., NFT) with the token ID corresponding to the order code C is located (identification module)
A partial amount TG of G is transferred from a crypto wallet of the device V2 according to the invention to the crypto wallet K in which the unique crypto value (e.g., NFT) with the token ID that forms the order code C is located.

V2 then transfers order and contract data from KG to a logistics infrastructure (e.g., Effektor) for shipping the goods to KG.

In addition, the following process steps can be described:
The device according to the invention, seller or V2, determines all transfers of TG's to all crypto wallets K in which the unique crypto value (e.g., NFT) with the token ID corresponding to the order code C has ever been located (evaluation module).
V2 or the seller totals all KG's with the unique crypto value (e.g., NFT) with the token ID corresponding to the order code C on
V2 or seller makes the amount of the summed KG's or all transfers of TG's to all crypto wallets K, in which the unique crypto value (e.g., NFT) with the specified TokenID has ever been located, generally or only for certain third parties, preferably accessible via the Internet or transfers this information directly to a specific third party
A unique crypto value (e.g., NFT) with the specified token ID is transferred from one crypto wallet K (Ki) to another crypto wallet K (Kj).
An amount of money in a cryptocurrency is transferred from one crypto wallet K (Kj) to another crypto wallet K (Ki).

When transferring L (e.g., as an NFT with a specific token ID) from Ki to Kj, the previous buyers KG are also automatically “passed on.” The identification module (EDP), which uniquely assigns the order code C (e.g., as a token ID) transmitted by KG to V2 to the crypto wallet K in which the license L (e.g., as an NFT with a specific token ID) is located, ensures that TG is actually transferred to the correct crypto wallet K.

If the commission for the sale were now to continue to flow to K1, even though the rights of L, which include, for example, the receipt of commissions for the sale of the goods, now lie with K2. It is therefore important that when L is transferred from K1 to K2, one of the two (K1 or K2) notifies V2 so that the order code C1, which was previously assigned to K1, is now assigned to K2. K2 is therefore assigned two order codes: its own and that of its predecessor K1. Let us assume the general case that there are a certain number M of licenses, whereby for a certain license, e.g., m less than or equal to M, there are already n−1 previous owners, then the license Lm has already been transferred n−1 times from one crypto wallet to another, so that it is now in the crypto wallet Kmn.

The order code C can be executed in various ways. First, it can be assigned to the crypto wallet in which the license Lm is currently located. Ideally, the order code is then executed as the address of the crypto wallet. Then, when an order code C is transferred from KG to V2, the control system identification module must decide whether this order code is still current, i.e., whether there is a license, e.g., Lm, in the wallet assigned to the order code. If this is the case, then after the legal transaction between KG and V2 has been completed, the partial amount TG is transferred to the wallet Kmn.

However, if there is no license in the wallet to which the order code is assigned, the identification module of V2 requires a suitable list, preferably in the form of a (dynamic) database, or access to the previous activities of the wallet assigned to the order code in order to find out which license was in this wallet in the past. This is preferably done by the module by accessing the relevant data in the blockchain (database). If the license Lm was previously in the wallet assigned to the order code transmitted by KG to V2, it must now be checked in which wallet Lm is currently stored. To do this, the identification module of V2 requires a device (method) that makes it possible to find out in which wallets Lm was previously stored and/or in which wallet Lm is currently stored. This is preferably done using a dynamic list (database) that regularly determines the current wallets in which the M issued licenses are located.

In another embodiment, the order code C is not assigned to a wallet in which a license is located, but to a (unique) crypto value that can be located in a corresponding crypto wallet. Ideally, the token ID of the license (NFT) is used for the order code C. Compared to the previous embodiment, this has the advantage that there are only a maximum of M order codes, which are easier to manage, especially if licenses are frequently transferred from one wallet to another. Then, only a dynamic list of the current wallet addresses needs to be maintained, and the order code only needs to be checked in relation to the current wallet and not in relation to the wallets in which the license was previously located (identification module).

This is preferably done via corresponding access (data analysis) to data in or from entries in the blockchain by the corresponding module.

Wallet, crypto wallet, and crypto wallet are used synonymously. Depending on the context, the Ks are also referred to as “third parties.”

The price (preferably in crypto currency) paid for the license L may be staggered over time.

An NFT can be generated (mined, minted) by V1 with the aid of a device provided by a provider or operator of an electronic platform P for the creation or trading of corresponding tokens (NFTs).

Real-world goods can be any mobile or immobile goods, commodities, or objects, as well as rights or obligations relating to the real world. In contrast, virtual world goods are objects or representations, e.g., for characters in online games, that only exist in virtual space and are therefore only indirectly available, i.e., only in electronic or digital form. An example of a real-world item is a drink that a person can actually drink, or a car that they can actually drive in the real world, or a picture that they can actually hang on the wall. An example of a virtual-world item is a picture that only exists in the form of bits and bytes and is only stored electronically as a digital “pattern.” You can look at it on a screen, but you can't actually hang it on a real wall.

The crypto wallet K1 is defined as a crypto wallet assigned to K1, etc.

To ensure that the good G received by KG is also original, an identification mechanism can be introduced. This defines the ownership of the good itself via a blockchain (e.g., NFT). To this end, the customer also acquires from KG the representation of the good G as a blockchain (e.g., NFT). Preferably, a unique code linked to the token must be affixed to the good G. Ideally, this is the token ID. In this way, the databases described above can be used to uniquely assign ownership of the good. Ownership of the asset can be proven by the presence of, for example, the NFT in the seller's wallet. If the asset were not in the seller's possession when it was sold, this would be immediately apparent. Ideally, the seller of the item transfers the NFT assigned to the item directly or indirectly to the buyer KG in exchange for the purchase price being transferred from the KG wallet to the seller's wallet (V2). Since the wallet in which the NFT is located can always be identified in the database, ownership can always be clearly proven.

In a special embodiment, at least two of the following steps apply:

A license L that establishes rights to an asset G is represented in a blockchain.

A license L represented in a blockchain is stored on a suitable electronic storage medium S, preferably an electronic trading platform P, for possible transfer (transfer).

A license L represented as a blockchain is transferred from a suitable electronic storage (memory) device to a suitable crypto wallet K.

K has an order code C and makes this available to a buyer KG of the good G, preferably by electronic means.

KG transfers the order code to V2.

An amount G is transferred from the crypto wallet KG to the crypto wallet V2.

A partial amount TG of G is transferred from the crypto wallet V2 to the crypto wallet K in which the license L is located.

All transfers of TG's from V2 to all crypto wallets K in which the license L has ever been located are linked to the associated license L (token ID) in a database.

All transfers of TG's to all crypto wallets K in which the license L has ever been located are made available on the Internet in general or only to certain users of the Internet, or this information is transferred directly to a specific user of the Internet.

The license L can be transferred from one crypto wallet Ki to another crypto wallet Kj.

A sum of money in a cryptocurrency is transferred from one crypto wallet K (Kj) to another crypto wallet K (Ki).

The license establishes the right to trade the good or to broker the good.

The blockchain representing the license is executed as a non-fungible token (NFT).

The electronic trading platform P is designed to enable trading, i.e., the purchase and sale of NFTs, by transferring the NFT from the trading platform P (storage, memory) to the crypto wallet K in exchange for a certain amount of cryptocurrency, preferably to the crypto wallet V1.

The license agreement is linked to the NFT that represents it in such a way that its content is readable as text with the aid of suitable electronic tools, at least for the owner of the crypto wallet in which the NFT is stored.

V1 and V2 may be identical.

The asset to which the license grants a right is a mobile or immobile object in the real world.

The license may also grant a right to only part of the asset.

An amount in cryptocurrency is transferred directly or indirectly from wallet K to wallet V1.

Electronic and digital are used synonymously throughout this document. Digital is a subset of electronic. Electronic can be analog electronic or digital electronic. If analog electronic is meant anywhere in the term electronic, this will be specifically mentioned.

Throughout this document, the terms wallet and crypto wallet are used synonymously, and crypto wallet or wallet of x is used synonymously with crypto wallet x or wallet x. Unless otherwise stated, wallet address x is equated with wallet x.

The current owner of a license is the person in whose wallet the license is located. The current, i.e., nth owner of the mth license Kmn is equated throughout this document with the electronic systems (e.g., device, process steps, and software) assigned to it, which represent it in the digital world of the process disclosed here. Kmn therefore also means wallet or crypto wallet or owner of Kmn. If only the characterizing symbol, e.g., K, or this symbol with an index, e.g., Ki, is used, it is considered a general representation of, for example, Kmn.

In this disclosure, the terms “system” and “module” refer to a preferably electronic device or electronic data processing system (EDP) or an electronic or electronically supported process with the aid of which certain steps of the present process can be carried out.

Each element of a particular embodiment or embodiment example or variant thereof can be combined with any element of another embodiment or embodiment example or variant thereof to form a new embodiment or embodiment example.

Electronic device, system, module, etc. preferably means electronic data processing system (EDP).

Each wallet is represented by a public and a private key, whereby the wallet address is derived from the public key and the wallet can only be accessed with the private key.

The phrase “with the help of the blockchain” is synonymous with “using the blockchain.” Unless otherwise specified, databases refer at least in part to the blockchain or at least an extracted representation of data (in or from entries) in the blockchain. This means that the databases mentioned in this disclosure are at least partially represented by the blockchain. Access to these databases is realized, for example, on the blockchain by extracting the data (information) used by suitable devices of the access or procurement system according to the invention.

The technical execution of the described processes (process steps) in the procurement system according to the invention is carried out using suitable devices, including the blockchain.

### 7. Universal Access System:

If, for example, an access or procurement applicant requires access to various objects that do not have a common logistical or organizational basis, they would need a corresponding access or procurement authorization from each of these issuing entities in the form of a separate license, e.g., through a different NFT in the access or procurement-seeking crypto wallet. For example, one NFT for access 1, such as a safe deposit box at a bank (issued by the bank's access system), and one NFT for the front door to an apartment (issued by a lock manufacturer). The access system then only checks whether the correct license (e.g., NFT) granting access is in the requesting crypto wallet. However, a device according to the invention is also conceivable in which only one issuing entity with only one license for all cases is in the requesting crypto wallet that requests access.

Overall, a universal access system can be created by means of a device according to the invention, in which an issuing authority provides a unique crypto value (e.g., NFT) as a license for access and orders, which can be transferred to the requesting crypto wallet. If there is an access restriction for an object or a purchase restriction for a good for an unauthorized group, the access or purchase authorization can be granted by entry in a database according to the invention of the valid wallet addresses or the valid unique crypto values or the valid identifiers (user group). This also applies to access authorizations for other objects or purchase authorizations for other goods. The access or procurement system or the devices according to the invention with the license previously granted for another object or good must then be extended to the technical system for managing access to the additional object or the purchase of the additional good. The same applies if, instead of or in addition to the unique crypto value, a wallet address or a unique identifier or a combination thereof forms the license. The license (unique crypto value or wallet address) can then be used as a universal key for granting access to a wide variety of objects or procurement to various goods.

In addition, a unique password can be assigned to the access or procurement applicant.

In all embodiments in which the license for the right to obtain access to an object or to obtain a good is represented by a unique crypto value, preferably a token (e.g., NFT), this unique crypto value must first be generated by or in a device, the entity or device granting this right (V, V1, S1, S, P, seller, device 1, device, etc.). In the case of NFTs, for example in an Ethereum-based network or a network derived from such, this creation process is referred to as “minting.” This creation (transaction) can be carried out using a suitable device of the system or with the aid of external structures using a blockchain, such as a corresponding platform (software, application) suitable for this purpose. The license (token) is then stored in the form of a token in a blockchain or represented by an entry via a transaction in the blockchain. In order to qualify a crypto wallet for the exercise of a corresponding access or subscription right, it is intended to transfer the unique crypto value to this crypto wallet, i.e., to transfer the power of disposal over this unique crypto value (e.g., NFT) to the crypto wallet to be qualified for the exercise of the right. This crypto wallet is then generally ready to perform the function of an requesting (access or subscription) crypto wallet, but may require further qualification for this function, depending on any additional criteria that may be specified for granting this function. In general, the token becomes a license when it is entered into the database of valid unique crypto values of an invention-compliant device of the access and procurement system, preferably after a suitable registration process.

The device according to the invention, as implemented for the release of access, can also be used in the same way for the active blocking of access. A separate description of such an embodiment is therefore not necessary, as it follows logically from the description of the invention in this document.

A device according to the invention can access the blockchain or data in or from entries in the blockchain in order to obtain data such as the wallet address of a crypto wallet that has a unique crypto value or is involved in a transaction (transfer of a crypto value, etc.), or whether and when a crypto wallet (with a specific wallet address) has had or still has a unique crypto value (e.g., NFT), or which unique crypto value or values a crypto wallet (with a specific wallet address) has ever had, or which identification code (TokenID, TID) a unique crypto asset has or may have, etc., can be read out or generated for possible processing by a device according to the invention (data processing, EDP). Accessing the blockchain means preferably accessing data (directly or indirectly) from (at least one) entry or entries in a blockchain network, for example with the aid of an Internet connection, or reading this data or processing it in accordance with the invention.

The wording “a crypto wallet requests access or procurement” means in practice that a party directly or indirectly requests access or procurement with the help of the crypto wallet or the crypto wallet, which is the tool that has the key (license) for access or procurement or for the transfer of a crypto value. The crypto wallet may be an element in the technical implementation of the access or procurement system. Part of the device according to the invention (e.g., that for exchanging a crypto value) may be designed as a crypto wallet.

The terms identifier, identification code, identification, information code, information, token ID, and license ID may be used interchangeably depending on the context. TokenID can be abbreviated to TID and LicenseID can be abbreviated to LID.

The wallet address of a crypto wallet K is preferably designated as WA. WA(K) indicates the wallet address of K. However, depending on the context, K can also stand for the wallet address of K.

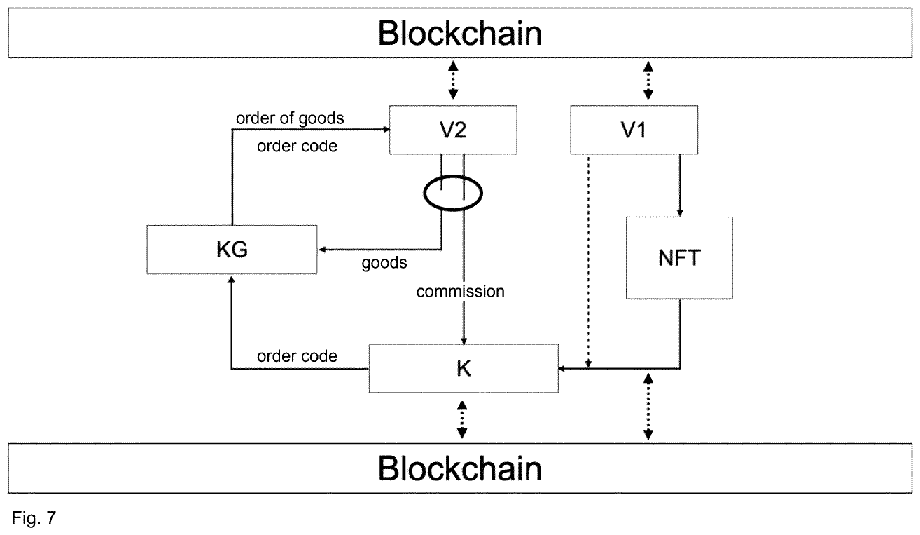

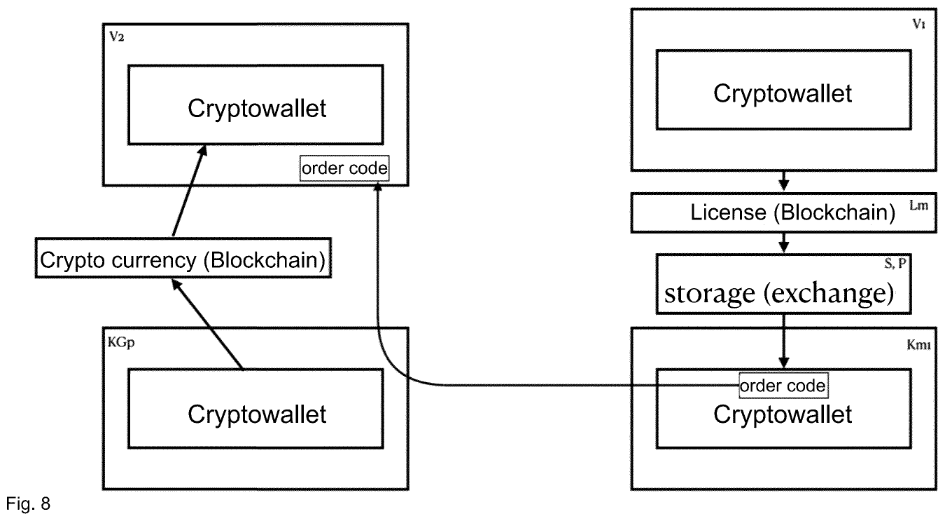

The components (elements) with which the crypto wallet communicates, such as S, P, V1, V2, V3, device 1, device 2, device, control, control device, G, S1, S3, seller, may be identical or interchangeable in their terminology (identical) and are designated differently depending on the embodiment. In a special embodiment, V2 and V1 (e.g., FIGS. 7, 8) may be identical (e.g., FIG. 6) or V1, V2, V3 may be interchangeable. S2 and K may also be identical.

The term “NFT” in the figures is to be understood as synonymous with the more general term “unique crypto asset” or “unique cryptocurrency” and does not constitute a fundamental restriction to an NFT as a special form of a unique crypto asset and synonymous crypto value. The term was chosen solely for the sake of simplicity.

The terms “control,” “control device,” “device,” or “device according to the invention” may be used, depending on the context, for the entire access or procurement system according to the invention or only for part thereof as a device according to the invention. In other words, the terms “device,” “device according to the invention,” “control,” “control device,” and “access or procurement system” can be used synonymously, depending on the context. Control or control device refer to a device according to the invention in the relevant context.

A sequence of process steps of a method according to the invention, without taking into account specific embodiments, can be represented as follows (e.g., FIG. 2):
Generation of a Unique Crypto Value (e.g., Nft).
Storage of the unique crypto value.
Transfer of the unique crypto value (e.g., NFT) from the storage device to a crypto wallet (1).
Exchange of a crypto value (signal) between the crypto wallet and a device according to the invention (2). Preferably, the crypto wallet transmits a signal to the device. The signal can also be transmitted in the opposite direction. The exchanged signal can also be the unique crypto value located in the crypto wallet.
Determination of whether the unique crypto value (e.g., NFT) represents an authorization (license) to access an object or to obtain a good.
If the unique crypto value represents an authorization (license) to access an object or obtain a good, access or procurement is granted (4).
If access or procurement is granted, an effector is activated that technically implements access or procurement (5).
The effector realizes access or procurement (6).
The access or procurement (purchase) has an effect in the real world (7).

Various embodiments and examples of use are listed as examples. However, many more embodiments and examples of use in accordance with the invention are conceivable. In many cases, different embodiments and their variants contain elements (components or process steps) that are identical or similar. In order to avoid having to describe each of these often identical elements in detail for each embodiment and thus listing an extremely large number of embodiments that would in any case result logically from the appropriate combination of corresponding elements of embodiments, it is hereby stated that all elements of all embodiments and their variants can be combined with all elements of all other embodiments and their variants to form further valid embodiments according to the invention.

### LIST OF REFERENCE NUMBERS

V1, V2, V3, S, S1, S3, P . . . Elements of the device according to the invention
K, S2 . . . Cryptowallet
TID, TokenID, LID, LicenseID . . . Identification code of a unique crypto value
NFT . . . Non-fungible token
L . . . License for access or procurement in accordance with the invention
1 . . . Transfer of a unique crypto value from a device according to the invention to a crypto wallet
2 . . . Transfer of a signal in the form of a crypto value from a crypto wallet to a device according to the invention (transaction)
3 . . . Transfer of the task of determining important transaction parameters such as the wallet address of a crypto wallet involved in a transaction or an identification code of a unique crypto value and determination of the existence of a specific access or procurement right
4 . . . Notification of the release or non-release of access or procurement
5 . . . Release or non-release of access or procurement for the crypto wallet involved
6 . . . Technical implementation of the release of access or procurement
7 . . . Effect of the release of access or procurement in the real world
C . . . Order code that is uniquely linked to a unique crypto value or its identification code.
DB . . . Database
WA . . . Wallet address of a crypto wallet
KG . . . Buyer of a good
TG . . . Partial amount of the purchase price for a good as commission for the brokerage
Am . . . Device for determining the current crypto wallet in which a license is located
G . . . Amount paid by a buyer for a good
P . . . Platform
S . . . Storage

1. An access or procurement system for controlling access to a location or object or technical system, or the procurement of goods or services, or the execution of a technical process in general, wherein the access or procurement system has at least one device (V1, V2, V3) for data exchange and a database (DB), wherein the device is designed that
the device can access data in or from entries in a blockchain,
the device can execute transactions using this blockchain or data derived from it by exchanging a signal in the form of a crypto value with a crypto wallet (K, S2) requesting access, procurement, or execution,
the device can determine the wallet address (WA) of a crypto wallet (K, S2) involved in such a transaction,
the device can determine whether the crypto wallet (K, S2) with the wallet address (WA) determined in this way has at least one unique crypto value whose identification code can be found in the database (DB), whose entries correspond to the identification codes of unique crypto values, whereby these unique crypto values registered in this database represent a license for the exercise of a right of access or procurement or execution by the crypto wallet (K, S2) seeking access, procurement or execution, provided that it the crypto wallet (K, S2) has a unique crypto value registered in the database (DB), and
if the license is available, it the device can execute accessing a location or object or technical system, or the procurement of a good or service, or the execution of a technical process.

2. The access or procurement system according to claim 1, wherein the device (V1, V2, V3) is suitable for generating a unique crypto value using a blockchain and transferring it the unique crypto value directly or indirectly to a crypto wallet (K, S2).

3. The access or procurement system according to claim 1, wherein the device (V1, V2, V3) has an effector which, when the device determines that a crypto wallet (K, S2) requesting access, procurement, or execution (K, S2) has a license to execute the access, procurement, or execution right in the form of a unique crypto value, can technically implement the execution of an access, procurement, or execution right by electrical, magnetic, electromagnetic, mechanical, optical, acoustic, thermal, or digital displays, processes, or specific devices.

4. The access or procurement system according to claim 1, wherein the device (V1, V2, V3) is designed in such a way that a crypto value can be transferred from the device to a crypto wallet (K, S2) if the device determines that this crypto wallet has a unique crypto value whose identification code has previously been transmitted to the device via a suitable interface.

5. The access or procurement system according to one claim 1, wherein the device (V1, V2, V3) is connected via an Internet connection to at least one blockchain or blockchain network.

6. The access or procurement system according claim 1, wherein the device (V1, V2, V3) is designed in such a way that unique crypto values are exchanged with crypto wallets (K, S2) via a different blockchain network, preferably via a “proof of work” blockchain network, as non-unique crypto values.

7. A computer-implemented method for operating the access or procurement system according to claim 1, wherein
the device (V1, V2, V3) accesses data in or from entries in a blockchain and, using this blockchain or data derived from the blockchain, executes transactions by exchanging a signal in the form of a crypto value with a crypto wallet (K, S2) requesting access, procurement, or execution,
wherein the device determines the wallet address (WA) of a crypto wallet involved in such a transaction, and
wherein the device (V1, V2, V3) determines whether the crypto wallet (K, S2) with the wallet address (WA) determined in this way has at least one unique crypto value whose identification code can be found in the database (DB), whose entries correspond to identification codes of unique crypto values, whereby these unique crypto values registered in the database represent a license for the exercise of a right of access or procurement or execution by the crypto wallet (K, S2) seeking access, procurement or execution, provided that it the crypto wallet (K, S2) has a unique crypto value registered in the database, and
wherein, if the license is available, access to a location or object or technical system, or the procurement of a good or service, or the execution of a technical process is granted.

8. A non-transitory computer program product comprising instructions for instructing the access or procurement system according to claim 1, which has at least one device (V1, V2, V3) for data exchange and a database (DB), to execute all process steps comprising:
accessing data in or from entries in a blockchain and, using this blockchain or data derived from the blockchain, executing transactions by exchanging a signal in the form of a crypto value with a crypto wallet (K, S2) requesting access, procurement, or execution,
determining the wallet address (WA) of a crypto wallet involved in such a transaction, and
determining whether the crypto wallet (K, S2) with the wallet address (WA) determined in this way has at least one unique crypto value whose identification code can be found in the database (DB), whose entries correspond to identification codes of unique crypto values, whereby these unique crypto values registered in the database represent a license for the exercise of a right of access or procurement or execution by the crypto wallet (K, S2) seeking access, procurement or execution, provided that the crypto wallet (K, S2) has a unique crypto value registered in the database, and
granting, if the license is available, access to a location or object or technical system, or the procurement of a good or service, or the execution of a technical process.
